(19) United States
(12) Patent Application Publication
(10) Pub. No.: US 2025/0094466 A1
(43) Pub. Date: Mar. 20, 2025

(54) STORAGE AND RETRIEVAL MECHANISMS FOR KNOWLEDGE ARTIFACTS ACQUIRED AND APPLICABLE ACROSS CONVERSATIONS

(71) Applicant: Oracle International Corporation, Redwood Shores, CA (US)

(72) Inventors: Raman Grover, Charlotte, NC (US); Amitabh Saikia, Mountain View, CA (US)

(73) Assignee: Oracle International Corporation, Redwood Shores, CA (US)

(21) Appl. No.: 18/830,344

(22) Filed: Sep. 10, 2024

Related U.S. Application Data
(60) Provisional application No. 63/583,022, filed on Sep. 15, 2023.

(51) Int. Cl. G06F 16/33; G06F 16/332; G06F 16/383

(52) U.S. Cl. CPC G06F 16/3344; G06F 16/3329; G06F 16/383

(57) ABSTRACT

Techniques are disclosed for storage and retrieval mechanisms for knowledge artifacts acquired and applicable across conversations to enrich user interactions with a digital assistant. In one aspect, a method includes receiving a natural language utterance form a user during a session between the user and the digital assistant and obtaining a topic context instance for the utterance. The obtaining includes executing a search, determining whether the utterance satisfies a threshold of similarity with one or more topics, identifying the topic context instance associated with the topics, and associating the utterance with the topic context instance. A first generative artificial intelligence model can then be used to generate a list of executable actions. An execution plan is then created, and the topic context instances is updated with the execution plan. The execution plan is then executed, and an output or communication derived from the output is sent to the user.

### CROSS-REFERENCE TO RELATED APPLICATION

The present application is a non-provisional application of and claims the benefit and priority under 35 U.S.C. 119 (c) of U.S. Provisional Application No. 63/583,022, filed on Sep. 15, 2023, the disclosure of which is incorporated herein by reference in its entirety for all purposes.

### FIELD

The present disclosure relates generally to digital assistants, and more particularly, to techniques for storage and retrieval mechanisms for knowledge artifacts acquired and applicable across conversations to enrich user interactions with a digital assistant.

### BACKGROUND

Artificial intelligence (AI) has diverse applications, with a notable evolution in the realm of digital assistants or chatbots. Originally, many users sought instant reactions through instant messaging or chat platforms. Organizations, recognizing the potential for engagement, utilized these platforms to interact with entities, such as end users, in real-time conversations.

However, maintaining a live communication channel with entities through human service personnel proved to be costly for organizations. In response to this challenge, digital assistants or chatbots, also known as bots, emerged as a solution to simulate conversations with entities, particularly over the Internet. The bots enabled entities to engage with users through messaging apps they already used or other applications with messaging capabilities.

Initially, traditional chatbots relied on predefined skill or intent models, which required entities to communicate within a fixed set of keywords or commands. Unfortunately, this approach limited an ability of the bot to engage intelligently and contextually in live conversations, hindering its capacity for natural communication. Entities were constrained by having to use specific commands that the bot could understand, often leading to difficulties in conveying intention effectively.

The landscape has since transformed with the integration of Large Language Models (LLMs) into digital assistants or chatbots. LLMs are deep learning algorithms that can perform a variety of natural language processing (NLP) tasks. They use a neural network architecture called a transformer, which can learn from the patterns and structures of natural language and conduct more nuanced and contextually aware conversations for various domains and purposes. This evolution marks a significant shift from rigid keyword-based interactions to a more adaptive and intuitive communication experience compared to traditional chatbots, enhancing the overall capabilities of digital assistants or chatbots in understanding and responding to user queries.

### BRIEF SUMMARY

In various embodiments, a computer-implemented method can be used for storage and retrieval of knowledge artifacts acquired and applicable across conversations to enrich a user interactions with a digital assistant. The computer-implemented method includes receiving, at a digital assistant, a natural language utterance from a user during a session between the user and the digital assistant; obtaining a topic context instance for the natural language utterance, where the obtaining comprises: executing, based on the natural language utterance, a search on a current session context instance, a data store, or both; based on the search, determining whether the natural language utterance satisfies a threshold level of similarity with one or more topics represented in the current session context instance, the data store, or both; responsive to determining the natural language utterance satisfies the threshold level of similarity with the one or more topics, identifying the topic context instance associated with the one or more topics; and associating the natural language utterance with the topic context instance; generating, by a first generative artificial intelligence model, a list comprising one or more executable actions based on one or more candidate actions associated with the topic context instance; creating, based on the list, an execution plan comprising the one or more executable actions; generating an updated topic context instance by updating the topic context instance to include the execution plan; executing the execution plan based on the updated topic context instance, where the executing comprises executing the executable action using an asset to obtain an output; and sending the output or a communication derived from the output to the user.

In some embodiments, generating the list comprises selecting the one or more executable actions from the one or more candidate actions based on each of the one or more executable actions satisfying a threshold level of similarity with the natural language utterance and context within the topic context instance.

In some embodiments, the computer-implemented method further comprises, responsive to a user logging into an application associated with the digital assistant, creating the current session context instance for the session, where the current session context instance comprises prior natural language utterances from the user during the session between the user and the digital assistant, and wherein each of the prior natural language utterances (a) is resolved and associated with the topic context instance or other topic context instance associated with the current session context instance or (b) is unresolved and associated with a tentative topic context instance.

In some embodiments, the digital assistant is configured to handle a plurality of actions associated with a plurality of topics including the one or more topics; the topic context instance is specific to the one or more topics and is associated one or more actions of the plurality of actions; and determining whether the natural language utterance satisfies the threshold level of similarity with the one or more topics is a function of similarity between the natural language utterance and the associated one or more actions.

In some embodiments, the computer-implemented method further comprises receiving, at the digital assistant, a subsequent natural language utterance from the user during the session between the user and the digital assistant; obtaining a tentative topic context instance for the subsequent natural language utterance, wherein the obtaining comprises: executing, based on the subsequent natural language utterance, a search on the current session context instance, the data store, or both, based on the search, determining the subsequent natural language utterance does not satisfy the threshold level of similarity with one or more topics represented in the current session context instance, the data store, or both, responsive to determining the subsequent natural language utterance does not satisfy the threshold level of similarity with the one or more topics, creating the tentative topic context instance associated with the current session context instance, and associating the subsequent natural language utterance with the tentative topic context instance.

In some embodiments, the computer-implemented method further comprises receiving, at the digital assistant, another subsequent natural language utterance from the user during the session between the user and the digital assistant; obtaining the topic context instance for the another subsequent natural language utterance, where the obtaining comprises executing, based on the another subsequent natural language utterance, a search on the current session context instance, the data store, or both, based on the search, determining the another subsequent natural language utterance satisfies the threshold level of similarity with the same or different one or more topics represented in the current session context instance, the data store, or both, responsive to determining the another subsequent natural language utterance satisfies the threshold level of similarity with the same or different one or more topics, identifying the same or different topic context instance associated with the same or different one or more topics, and associating the another subsequent natural language utterance with the same or different topic context instance.

In some embodiments, the computer-implemented method further comprises responsive to receiving the another subsequent natural language utterance from the user, reevaluating the subsequent natural language utterance associated with the tentative topic context instance, wherein the reevaluating comprises: executing, based on the subsequent natural language utterance, a search on the current session context instance, the data store, or both, based on the search, determining the subsequent natural language utterance satisfies the threshold level of similarity with the same or different one or more topics represented in the current session context instance, the data store, or both, responsive to determining the subsequent natural language utterance satisfies the threshold level of similarity with the same or different one or more topics, identifying the same or different topic context instance associated with the same or different one or more topics, and associating the subsequent natural language utterance with the same or different topic context instance.

In some embodiments, the natural language utterance references a prior conversation between the user and the digital assistant; obtaining the topic context instance for the natural language utterance further comprises: based on the reference to the prior conversation and the search, identifying a past topic context instance associated with the same or different one or more topics, and linking, using a virtual pointer, the topic context instance with the past topic context instance; and the one or more executable actions are selected from the one or more candidate actions based on each of the one or more executable actions satisfying the threshold level of similarity with the natural language utterance, the context within the topic context instance, and additional context within the past topic context instance.

In some embodiments, responsive to determining the natural language utterance satisfies the threshold level of similarity with the one or more topics, identifying multiple topic context instances associated with the current session context instance and associated with the one or more topics; and obtaining the topic context instance for the natural language utterance further comprises merging the multiple topic context instances to create the topic context instance as a composite of the multiple topic context instances.

In some embodiments, the context within the topic context instance includes a conversation history between the user and the digital assistant; context within each of the multiple topic context instances includes additional conversation history between the user and the digital assistant; and merging the multiple topic context instances includes concatenating the conversation history with each of the additional conversation histories.

In some embodiments, the one or more candidate actions are identified as being associated with the topic context instance by executing, using the natural language utterance, a semantic search of potential actions represented in the data store that are associated with the digital assistant; the potential actions have a zero confidence level for satisfying the threshold level of similarity with the natural language utterance and the context within the topic context instance; the one or more candidate actions have a positive confidence level for satisfying the threshold level of similarity with the natural language utterance and the context within the topic context instance, and the one or more executable actions have a positive confidence level and do satisfy the threshold level of similarity with the natural language utterance and the context within the topic context instance, based on which the first generative artificial intelligence model predicts that the one or more executable actions are relevant for responding to the natural language utterance with a high confidence level.

In some embodiments, the computer-implemented method further comprises constructing, based on the topic context instance, an input prompt comprising the one or more candidate actions, at least a portion of the context associated with the topic context instance, and the natural language utterance; and providing the input prompt to the first generative artificial intelligence model, wherein the first generative artificial intelligence model generates the list comprising the executable action based on the input prompt.

In some embodiments, the computer-implemented method further comprises executing, based on the one or more candidate actions, a search on user-preferences in the data store to identify one or more user-preferences that are relevant to the one or more candidate actions, wherein the creating the execution plan comprises embedding the one or more user-preferences into the execution plan.

In some embodiments, the context within the topic context instance includes a conversation history between the user and the digital assistant; and the current session context instance is associated with the topic context instance and one or more other topic context instances, each of the one or more other topic context instances includes additional conversation history between the user and the digital assistant.

In some embodiments, the computer-implemented method further comprises generating a summary of the conversation history and the additional conversation history between the user and the digital assistant; revising the current session context instance to include the summary of the conversation history; and computing performance metrics for the digital assistant based on the revised current session context instance.

In some embodiments, the computer-implemented method further comprises constructing, based on the output and the topic context instance, an input prompt comprising the output, at least a portion of the context associated with the topic context instance, and the natural language utterance; providing the input prompt to a second generative artificial intelligence model; and generating, by the second generative artificial intelligence model, a response to the natural language utterance based on the input prompt, wherein the response is the communication derived from the output.

Some embodiments include a system including one or more processors and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating a chatbot system in accordance with various embodiments.

FIG. 2 is an exemplary architecture for an LLM-based digital assistant in accordance with various embodiments.

FIG. 3 is a simplified block diagram of a computing environment including a digital assistant that can execute an execution plan incorporating contextual information to respond to an utterance from a user in accordance with various embodiments.

FIG. 4 is a simplified block diagram illustrating a computing environment including a context and memory store that can store prior knowledge and contextual information in accordance with various embodiments.

FIG. 5 is a simplified block diagram illustrating data flows for managing contextual information surrounding user interactions with a digital assistant using a context and memory store in accordance with various embodiments.

FIG. 6 is a flowchart of a process for responding to a query using knowledge information (e.g., context) from a context and memory store in accordance with various embodiments.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Artificial intelligence techniques have broad applicability. For example, a digital assistant is an artificial intelligence driven interface that helps users accomplish a variety of tasks using natural language conversations. Conventionally, for each digital assistant, a customer may assemble one or more skills that are focused on specific types of tasks, such as tracking inventory, submitting timecards, and creating expense reports. When an end user engages with the digital assistant, the digital assistant evaluates the end user input for the intent of the user and routes the conversation to and from the appropriate skill based on the user's perceived intent. However, there are some disadvantages of traditional intent-based skills including a limited understanding of natural language, inability to handle unknown inputs, limited ability to hold natural conversations off script, and challenges integrating external knowledge.

The advent of large language models (LLMs) like GPT-4 has propelled the field of digital assistant design to unprecedented levels of sophistication and overcome these disadvantages and others of traditional intent-based skills. An LLM is a neural network that employs a transformer architecture, specifically crafted for processing and generating sequential data, such as text or words in conversations. LLMs undergo training with extensive textual data, gradually honing their ability to generate text that closely mimics human-written or spoken language. While LLMs excel at predicting the next word in a sequence, it's important to note that their output isn't guaranteed to be entirely accurate. Their text generation relies on learned patterns and information from training data, which could be incomplete, erroneous, or outdated, as their knowledge is confined to their training dataset. LLMs don't possess the capability to recall facts from memory; instead, their focus is on generating text that appears contextually appropriate.

Conventional techniques for implementing a digital assistant may process queries or user utterances in isolation. Processing queries in isolation means that each interaction with a digital assistant is handled as if it were a standalone request, without any regard for the previous context or conversation history. This approach can be highly problematic because human conversations are inherently contextual. Each utterance often builds on the previous ones, relying on shared knowledge and prior exchanges to create a coherent dialogue. Without the ability to reference past interactions and shared knowledge, a digital assistant may provide responses that are disjointed, repetitive, or irrelevant, leading to user frustration and a breakdown in effective communication. For example, if a user asks a series of questions about a specific medical case, processing each question in isolation could result in the digital assistant giving generic answers that fail to address the nuances of the ongoing discussion.

For large language model (LLM) based digital assistants, this challenge is particularly acute. LLMs, such as those based on the GPT architecture, are designed to generate human-like text based on input data. They excel at understanding and producing contextually relevant responses when they have access to the entire conversation history and knowledge base. When an LLM processes queries in isolation, it loses the ability to leverage this conversational context and shared knowledge, which can degrade the quality of its outputs. The LLM may fail to recognize the continuity of topics, miss out on important details mentioned earlier or provided within the knowledge base, or provide answers that seem out of place. This limitation not only hampers the user experience but also undermines the potential of LLMs to deliver sophisticated, context-aware assistance.

To address these challenges and others, techniques are disclosed herein to grant LLM based digital assistants with access to context and external knowledge sources, which can help an LLM based digital assistant understand and recall context from previous conversations or sessions to allow for seamless memory emulation during a conversation and aid a user with more accurate and tailored support. The incremental knowledge gained with each utterance from the end-user can contribute to context. This can be coupled with prior knowledge of the digital assistant based on processing knowledge base(s) to form the overall memory for the digital assistant. The overall memory is realized using a context and memory store, which acts as a single repository for this knowledge (short-term and/or long-term) acquired and applicable across conversations. The context and memory store is configured to provide a mechanism to add and access the accumulated knowledge in an efficient way, while hiding the intricacies of the physical layout, storage and indexing aspects. It offers a rich and efficient retrieval mechanism (semantic, indexed search) over the contents, together with lifecycle management, upon which for upstream application to build. More specifically, the context and memory store can act as a repository for context and related artifacts to be stored, indexed, and queried reliably. The context and memory store can offer APIs, SDK, and CLI for clients to interface. Context, conversation, and session form some of the key concepts in this storage and retrieval paradigm. For each of the foregoing, a single unified definition can be used across the ecosystem.

In various embodiments, a computer-implemented method is provided for storage and retrieval of knowledge artifacts acquired and applicable across conversations to enrich user interactions with a digital assistant. The computer-implemented method includes receiving, at a digital assistant, a natural language utterance from a user during a session between the user and the digital assistant; obtaining a topic context instance for the natural language utterance, where the obtaining comprises: executing, based on the natural language utterance, a search on a current session context instance, a data store, or both; based on the search, determining whether the natural language utterance satisfies a threshold level of similarity with one or more topics represented in the current session context instance, the data store, or both; responsive to determining the natural language utterance satisfies the threshold level of similarity with the one or more topics, identifying the topic context instance associated with the one or more topics; and associating the natural language utterance with the topic context instance; generating, by a first generative artificial intelligence model, a list comprising one or more executable actions based on one or more candidate actions associated with the topic context instance; creating, based on the list, an execution plan comprising the one or more executable actions; generating an updated topic context instance by updating the topic context instance to include the execution plan; executing the execution plan based on the updated topic context instance, where the executing comprises executing the executable action using an asset to obtain an output; and sending the output or a communication derived from the output to the user.

As used herein, when an action is “based on” something, this means the action is based at least in part on at least a part of the something. As used herein, the terms “similarly”, “substantially,” “approximately” and “about” are defined as being largely but not necessarily wholly what is specified (and include wholly what is specified) as understood by one of ordinary skill in the art. In any disclosed embodiment, the term “similarly”, “substantially,” “approximately,” or “about” may be substituted with “within [a percentage] of” what is specified, where the percentage includes 0.1, 1, 5, and 10 percent.

### Digital Assistant and Knowledge Dialog

A bot (also referred to as an agent, chatbot, chatterbot, or talkbot), implemented as part of or as a digital assistant, is a computer program that can perform conversations with end users. The bot can generally respond to natural-language messages (e.g., questions or comments) through a messaging application that uses natural-language messages. Enterprises may use one or more bot systems to communicate with end users through a messaging application. The messaging application, which may be referred to as a channel, may be an end user preferred messaging application that the end user has already installed and familiar with. Thus, the end user does not need to download and install new applications in order to chat with the bot system. The messaging application may include, for example, over-the-top (OTT) messaging channels (such as Facebook Messenger, Facebook WhatsApp, WeChat, Line, Kik, Telegram, Talk, Skype, Slack, or SMS), virtual private assistants (such as Amazon Dot, Echo, or Show, Google Home, Apple HomePod, etc.), mobile, web, and cloud application extensions or plugins that extend native or hybrid/responsive mobile, web, or cloud applications with chat capabilities, or voice based input (such as devices or apps with interfaces that use Siri, Cortana, Google Voice, or other speech input for interaction).

In some examples, a bot system may be associated with a Uniform Resource Identifier (URI). The URI may identify the bot system using a string of characters. The URI may be used as a webhook for one or more messaging application systems. The URI may include, for example, a Uniform Resource Locator (URL) or a Uniform Resource Name (URN). The bot system may be designed to receive a message (e.g., a hypertext transfer protocol (HTTP) post call message) from a messaging application system. The HTTP post call message may be directed to the URI from the messaging application system. In some embodiments, the message may be different from a HTTP post call message. For example, the bot system may receive a message from a Short Message Service (SMS). While discussion herein may refer to communications that the bot system receives as a message, it should be understood that the message may be an HTTP post call message, a SMS message, or any other type of communication between two systems.

End users may interact with the bot system through a conversational interaction (sometimes referred to as a conversational user interface (UI)), just as interactions between people. In some cases, the interaction may include the end user saying “Hello” to the bot and the bot responding with a “Hi” and asking the end user how it can help. In some cases, the interaction may also be a transactional interaction with, for example, a banking bot, such as transferring money from one account to another; an informational interaction with, for example, a HR bot, such as checking for vacation balance; or an interaction with, for example, a retail bot, such as discussing returning purchased goods or seeking technical support.

In some embodiments, the bot system may intelligently handle end user interactions without interaction with an administrator or developer of the bot system. For example, an end user may send one or more messages to the bot system in order to achieve a desired goal. A message may include certain content, such as text, emojis, audio, image, video, or other method of conveying a message. In some embodiments, the bot system may convert the content into a standardized form (e.g., a representational state transfer (REST) or API call against enterprise services with the proper parameters) and generate a natural language response. The bot system may also prompt the end user for additional input parameters or request other additional information. In some embodiments, the bot system may also initiate communication with the end user, rather than passively responding to end user utterances. Described herein are various techniques for identifying an explicit invocation of a bot system and determining an input for the bot system being invoked. In certain embodiments, explicit invocation analysis is performed by a master bot based on detecting an invocation name in an utterance. In response to detection of the invocation name, the utterance may be refined or pre-processed for input to a bot that is identified to be associated with the invocation name and/or communication.

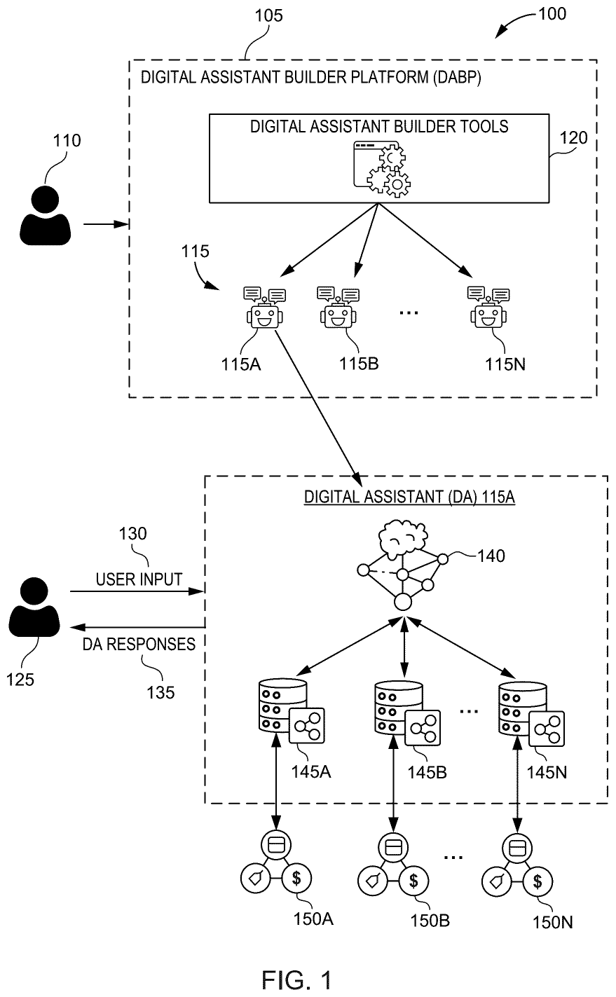

FIG. 1 is a simplified block diagram of an environment 100 incorporating a digital assistant system (also described herein as simply a digital assistant or in more specific terms with reference to implementation of agents as an agent assistant) according to certain embodiments. Environment 100 includes a digital assistant builder platform (DABP) 105 that enables users 110 to create and deploy digital assistant systems 115. For purposes of this disclosure, a digital assistant is an entity that helps users of the digital assistant accomplish various tasks through natural language conversations. The DABP and digital assistant can be implemented using software only (e.g., the digital assistant is a digital entity implemented using programs, code, or instructions executable by one or more processors), using hardware, or using a combination of hardware and software. In some instances, the environment 100 is part of an Infrastructure as a Service (IaaS) cloud service (as described below in detail) and the DABP and digital assistant can be implemented as part of the IaaS by leveraging the scalable computing resources and storage capabilities provided by the IaaS provider to process and manage large volumes of data and complex computations. This setup allows the DABP and digital assistant to deliver real-time, responsive interactions while ensuring high availability, security, and performance scalability to meet varying demand levels. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable. DABP 105 can be used to create one or more digital assistant systems (or DAs). For example, as illustrated in FIG. 1, user 110 representing a particular enterprise can use DABP 105 to create and deploy a digital assistant 115A for users of the particular enterprise. For example, DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use DABP 105 to create and deploy digital assistant 115B that enables customers of the restaurant to order food (e.g., order pizza).

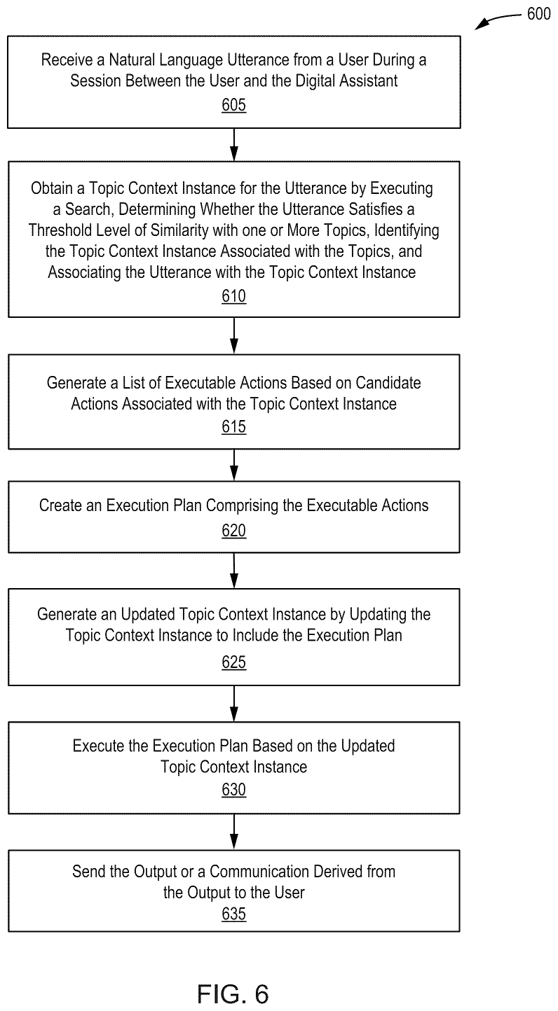

To create one or more digital assistant systems 115, the DABP 105 is equipped with a suite of tools 120, enabling the acquisition of LLMs, agent creation, asset identification, and deployment of digital assistant systems within a service architecture for users via a computing platform such as a cloud computing platform described in detail with respect to FIGS. 6-10. In some instances, the tools 120 can be utilized to access pre-trained and/or fine-tuned LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval on behalf of an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 120 can be utilized to pre-train and/or fine-tune the LLMs. The tools 120, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 120 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

The tools 120 further include a prompt-based agent composition unit for creating agents and their associated actions that an end-user can end up invoking. An agent is a container of agent actions and can be part of one or more digital assistants. Each digital assistant may contain one or more agents through a digital assistant relation, which is the intersection entity that links an agent to a digital assistant. The agent and digital assistant are implemented as bot subtypes and may be persisted into an existing BOTS table. This has advantages in terms of reuse of design-time code (e.g., Java code) and UI artefacts.

An agent action is of a specific action type (e.g., knowledge, service or API, LLM, etc.) and contains a description and schema (e.g., JSON schema) which defines the action parameters. The action description and parameters schema are indexed by semantic index and sent to the planner LLM to select the appropriate action(s) to execute. The action parameters are key-value pairs that are input for the action execution. They are derived from the properties in the schema but may also include additional UI/dialog properties that are used for slot filling dialogs. The actions can be part of one or more classes. For example, some actions may be part of an application event subscription class, which defines an agent action that should be executed when an application event is received. The application event can be received in the form of un update application context command message. An application event property mapping class (part of the application event subscription class) specifically maps the application event payload properties to corresponding agent action parameters. An action can optionally be part of an action group. An action group may be used when importing a plugin manifest, or when importing an external API spec such as an Open API spec. An action group is particularly useful when re-importing a plugin or open API spec, so new actions can be added, existing actions can be updated, or actions that are no longer present in the new manifest or Open API spec can be removed. At runtime, an action group may only be used to limit the application context groups that are sent to the LLM as conversation context by looking up the action group name which corresponds to a context group context.

The agents (e.g., 401k Change Contribution Agent) may be primarily defined as a compilation of agent artifacts using natural language within the prompt-based agent composition unit. Users 110 can create functional agents quickly by providing agent artifact information, parameters, and configurations and by pointing to assets. The assets can be or include resources, such as APIs for interfacing with applications, files and/or documents for retrieving knowledge, data stores for interacting with data, and the like, available to the agents for the execution of actions. The assets are imported, and then the users 110 can use natural language again to provide additional API customizations for dialog and routing/reasoning. Most of what an agent does may involve executing actions. An action can be an explicit action that's authored using natural language (similar to creating agent artifacts—e.g., ‘What is the impact of XYZ on my 401k Contribution limit?’ action in the below ‘401k Contribution Agent’ figure) or an implicit action that is created when an asset is imported (automatically imported upon pointing to a given asset based on metadata and/or specifications associated with the asset—e.g., actions created for Change Contribution and Get Contribution API in the below ‘401k Contribution Agent’ figure). The design time user can easily create explicit actions. For example, the user can choose the ‘Rich Text’ action type (see Table 1 for a list of exemplary action types) and creates the name artifact ‘What is the impact of XYZ on my 401k Contribution limit?’ when the user learns that a new FAQ needs to be added, as it's not currently in the knowledge documents (assets) the agent references (thus was not implicitly added as an action).

TABLE 1

| | Action Type | Description |
|---|---|---|
| 1 | Prompt | The action is implemented using a prompt to an LLM. |
| 2 | Rich Text | The action is implemented using rich text. The |
| | | most common use case is FAQs. |
| 3 | Flow | The action is implemented using Visual |
| | | Flow Designer flow. May be used for complex |
| | | cases where the developer is not able to |
| | | use the out-of-the-box |
| | | dialogue and dialog customizations. |

There are various ways in which the agents and assets can be associated or added to a digital assistant 115. In some instances, the agents can be developed by an enterprise and then added to a digital assistant using DABP 105. In other instances, the agents can be developed and created using DABP 105 and then added to a digital assistant created using DABP 105. In yet other instances, DABP 105 provides an online digital store (referred to as an “agent store”) that offers various pre-created agents directed to a wide range of tasks and actions. The agents offered through the agent store may also expose various cloud services. In order to add the agents to a digital assistant being generated using DABP 105, a user 110 of DABP 105 can access assets via tools 120, select specific assets for an agent, initiate a few mock chat conversations with the agent, and indicate that the agent is to be added to the digital assistant created using DABP 105.

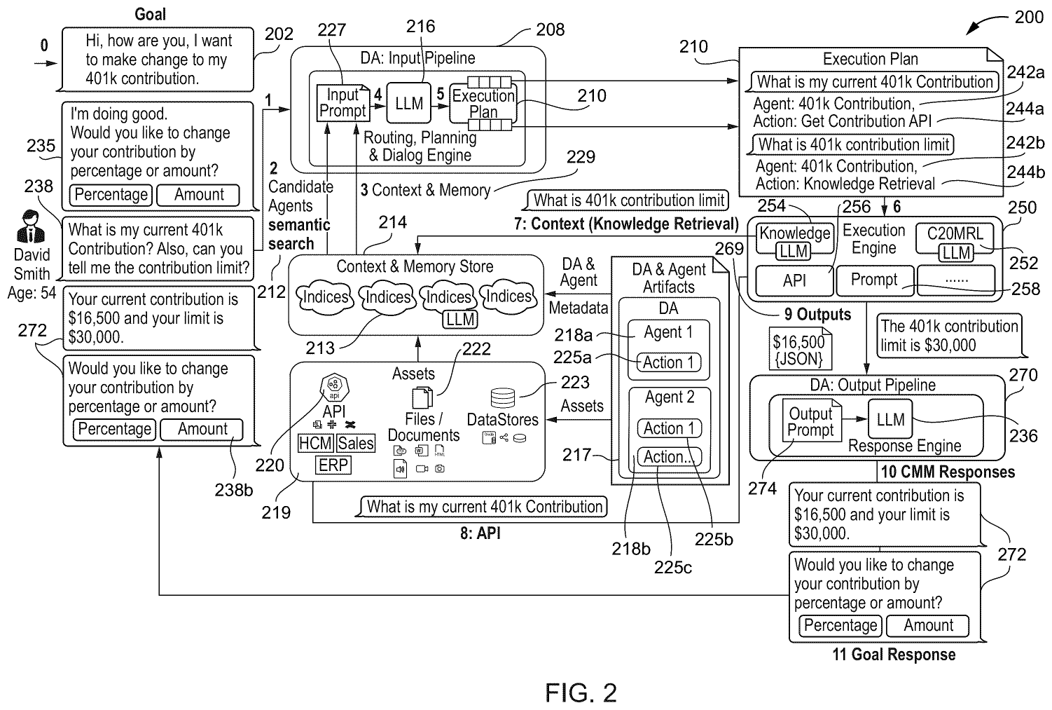

Once deployed in a production environment, such as the architecture described with respect to FIG. 2, a digital assistant, such as digital assistant 115A built using DABP 105, can be used to perform various tasks via natural language-based conversations between the digital assistant 115A and its users 125. As described above, the digital assistant 115A illustrated in FIG. 1, can be made available or accessible to its users 125 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 125 may provide one or more user inputs 130 to digital assistant 115A and get responses 135 back from digital assistant 115A via a user interface element such as a chat window. A conversation can include one or more of user inputs 130 and responses 135. Via these conversations, a user 125 can request one or more tasks to be performed by the digital assistant 115A and, in response, the digital assistant 115A is configured to perform the user-requested tasks and respond with appropriate responses to the user 125 using one or more LLMs 140. Conversations shown in the chat window can be organized by thread. For example, in some applications, a conversation related to one page of an application should not be mixed with a conversation related to another page of the application. The application and/or the plugins for the application define the thread boundaries (e.g., a set of (nested) plugins can run within their own thread). Effectively, the chat window will only show the history of messages that belong to the same thread. Setting and changing the thread can be performed via the application and/or the plugins using an update application context command message. Additionally or alternatively, the thread can be changed via an execution plan orchestrator when a user query is matched to a plugin semantic action and the plugin runs in a thread different than the current thread. In this case, the planner changes threads, so that any messages sent in response to the action being executed are shown in the correct new thread. Per agent dialog thread, the following information can be maintained by the digital assistant: the application context, the LLM conversation history, the conversation history with the user, and the agent execution context which holds information about the (stacked) execution plan(s) related to this thread.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115A. In some embodiments, a user input 130 can be in audio input or speech form, such as when a user says or speaks something that is provided as input to digital assistant 115A. The user inputs 130 are typically in a language spoken by the user 125. For example, the user inputs 130 may be in English, or some other language. When a user input 130 is in speech form, the speech input is converted to text form user input 130 in that particular language and the text utterances are then processed by digital assistant 115A. Various speech-to-text processing techniques may be used to convert a speech or audio input to a text utterance, which is then processed by digital assistant 115A. In some embodiments, the speech-to-text conversion may be done by digital assistant 115A itself. For purposes of this disclosure, it is assumed that the user inputs 130 are text utterances that have been provided directly by a user 125 of digital assistant 115A or are the results of conversion of input speech utterances to text form. This however is not intended to be limiting or restrictive in any manner.

The user inputs 130 can be used by the digital assistant 115A to determine a list of candidate agents 145A-N. The list of candidate agents (e.g., 145A-N) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115A. Metadata for the candidate agents 145A-N in the list of candidate agents is then combined with the user input to construct an input prompt for the one or more LLMs 140.

Digital assistant 115A is configured to use one or more LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pretrained language model such as BERT, or the like.

Upon understanding the meaning of an utterance, the one or more LLMs 140 generate an execution plan that identifies one or more agents (e.g., agent 145A) from the list of candidate agents to execute and perform one or more actions or operations responsive to the understood meaning or goal of the user. The one or more actions or operations are then executed by the digital assistant 115A on one or more assets (e.g., asset 150A-knowledge, API, SQL operations, etc.) and/or the context and memory store. The execution of the one or more actions or operations generates output data from one or more assets and/or relevant context and memory information from a context and memory store comprising context for a present conversation with the digital assistant 115A. The output data and relevant context and memory information are then combined with the user input 130 to construct an output prompt for one or more LLMs 140. The LLMs 140 synthesize the response 135 to the user input 130 based on the output data and relevant context and memory information, and the user input 130. The response 135 is then sent to the user 125 as an individual response or as part of a conversation with the user 125.

For example, a user input 130 may request a pizza to be ordered by providing an utterance such as “I want to order a pizza.” Upon receiving such an utterance, digital assistant 115A is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user may be generated by executing an action via an agent (e.g., agent 145A) on a knowledge asset (e.g., a menu for a pizza restaurant) to retrieve information that is pertinent to ordering a pizza (e.g., to order a pizza a user must provide type, seize, topping, etc.). The responses 135 provided by digital assistant 115A may also be in natural language form and typically in the same language as the user input 130. As part of generating these responses 135, digital assistant 115A may perform natural language generation (NLG) using the one or more LLMs 140. For the user ordering a pizza, via the conversation between the user and digital assistant 115A, the digital assistant 115A may guide the user to provide all the requisite information for the pizza order, and then at the end of the conversation cause the pizza to be ordered. The ordering may be performed by executing an action via an agent (e.g., agent 145A) on an API asset (e.g., an API for ordering pizza) to upload or provide the pizza order to the ordering system of the restaurant. Digital assistant 115A may end the conversation by generating a final response 135 providing information to the user 125 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115A including one or more LLMs 140 and one or more agents 145A-N, this is not intended to be limiting. A digital assistant can include various other components (e.g., other systems and subsystems as described in greater detail with respect to FIG. 2) that provide the functionalities of the digital assistant. The digital assistant 115A and its systems and subsystems may be implemented only in software (e.g., code, instructions stored on a computer-readable medium and executable by one or more processors), in hardware only, or in implementations that use a combination of software and hardware.

FIG. 2 is an example of an architecture for a computing environment 200 for a digital assistant implemented with generative artificial intelligence in accordance with various embodiments. As illustrated in FIG. 2, an infrastructure and various services and features can be used to enable a user to interact with a digital assistant (e.g., digital assistant 115A described with respect to FIG. 1) based at least in part on a series of prompts such as a conversation and/or a series of actions such as interactions with a user interface. The following is a detailed walkthrough of a conversation flow and the role and responsibility of the components, services, models, and the like of the computing environment 200 within a conversation flow. In this walkthrough, it is assumed that a user “David” is interested in making a change to his 401k contribution, and in an utterance 202, David provides the following input: Hi, how are you, I want to make a change to my 401k contribution. The utterance 202 can be communicated to the digital assistant (e.g., via a digital assistant user interface such as a text dialogue box or microphone). At this stage upon receipt of the utterance 202, a sessionizer creates a new session or retrieves the current session context and a user message publisher updates session transcript and LLM message history with the new user message (e.g., utterance 202).

In instances where the user provides the utterance 202 and/or performs an action while using an application supported by a digital assistant, the application issues update application context commands as the user interacts with the application (e.g., provides an utterance via text or audio, triggers a user interface element, navigates between pages of the application, and the like). Whenever an update application context command message is received by the digital assistant from the application, the application context processor (part of the context manager) is implemented. The application context processor performs the following tasks: (i) manages dialog threads based on the application context message, e.g., if the threadId specified with the message doesn't exist yet, a new dialog thread is created and made current, and if the threadId already exists, the corresponding dialog thread is made current, (ii) creates or updates the application context object for the current dialog thread, (iii) if a service call ID such as a REST request ID is included, the application context may be enriched (as described in greater detail herein). As should be understood, the application context only contains information that reflects the state of the application user interface and plugins (if available), it does not contain other state information (e.g., user or page state information/context).

Is some instances, when an update application context command message is received, an application event processor checks on whether the update application context command message includes an event definition. The event is uniquely identified by the following properties in the message payload: (i) context: the context path and/or the plugin path (For a top-level workspace plugin the context is set to the plugin name, for nested plugins the plugin path is included where plugins are separated with a slash, for example Patient/Vitalschart), (ii) eventType: the type of event can be one of the built in events or a custom event, and (iii) semantic object: the semantic object to which the event applies. An event can be mapped to one or more actions, and the message payload properties can be mapped to action parameters. This mapping takes place through an application event subscription. Each property in the message payload can be mapped to an agent action parameter using an application event property mapping.

In some instances, the utterance 202 and/or action performed by the user is provided directly as input to a planner 208. In other instances where the application event processor is implemented, the utterance 202 and/or action performed by the user is provided as input to the planner 208 when the application event processor determines an event such as receipt of utterance 202 is mapped to an agent or action associated with the digital assistant. The planner 208 is used by the digital assistant to create an execution plan 210 with specified parameters either from the utterance 202, the action performed by the user, the context, or any combination thereof. The execution plan 210 identifies one or more agents and/or one or more actions for the one or more agents to execute in response to the utterance 202 and/or action performed by the user.

A two-step approach can be taken via the planner 208 to generate the execution plan 210. First, a search 212 can be performed to identify a list of candidate agents and/or actions. The search 212 comprises running a query on indices 213 (e.g., semantic indices) of a context and memory store 214 based on the utterance 202 and/or action performed by the user. In some instances, the search 212 is a semantic search performed using words from the utterance 202 and/or representative of the action performed by the user. The semantic search uses NLP and optionally machine learning techniques to understand the meaning of the utterance 202 and/or action performed by the user and retrieve relevant information from the context and memory store 214. In contrast to traditional keyword-based searches, which rely on exact matches between the words in the query and the data in the context and memory store 214, a semantic search takes into account the relationships between words, the context of the query and/or action, synonyms, and other linguistic nuances. This allows the digital assistant to provide more accurate and contextually relevant results, making it more effective in understanding the user's intent in the utterance 202 and/or action performed by the user.

In order to run the query, the planner 208 calls the context and memory store 214 (e.g., a semantic index of the context and memory store 214) to get the list of candidate agents and/or actions. The following information is passed in the call: (i) the ID of the digital assistant (the ID scopes the set of agent and/or actions the semantic index will search for and thus the agents and/or actions must be part of the digital assistant), and (ii) the last X number of user messages and/or actions (e.g., X can be set to the last 5 turns), which can be configurable through the digital assistant settings.

The context and memory store 214 is implemented using a data framework for connecting external data to LLMs 216 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 217 associated with the digital assistant and its agents 218 (e.g., 218a and 218b). The artifacts 217 for the digital assistant include information on the general capabilities of the digital assistant and specific information concerning the capabilities of each of the agents 218 (e.g., actions) available to the digital assistant (e.g., agent artifacts). Additionally or alternatively, the artifacts 217 can encompass parameters or information associated with the artifacts 217 and that can be used to define the agents 218 in which the parameters or information associated with the artifacts 217 can include a name, a description, one or more actions, one or more assets, one or more customizations, etc. In some instances, the data further includes metadata extracted from assets 219 associated with the digital assistant and its agents 218 (e.g., 218a and 218b). The assets 219 may be resources, such as APIs 220, files and/or documents 222, data stores 223, and the like, available to the agents 218 for the execution of actions (e.g., actions 225a, 225b, and 225c). The data is indexed in the context and memory store 214 as indices 213, which are data structures that provide a fast and efficient way to look up and retrieve specific data records within the data. Consequently, the context and memory store 214 provides a searchable comprehensive record of the capabilities of all agents and associated assets that are available to the digital assistant for responding to the request and/or action.

The response of context and memory store 214 is converted into a list of agent and/or action instances that are not just available to the digital assistant for responding to the request but also potentially capable of facilitating the generation of a response to the utterance 202 and/or action performed by the user. The list of candidate agents and/or actions includes the metadata (e.g., metadata extracted from artifacts 217 and assets 219) from the context and memory store 214 that is associated with each of the candidate agents and/or actions. The list can be limited to a predetermined number of candidate agents and/or actions (e.g., top 10) that satisfy the query or can include all agents and/or actions that satisfy the query. The list of candidate agents and/or actions with associated metadata is appended to the utterance 202 and/or action performed by the user to construct an input prompt 227 for the LLM 216. The search 212 is important to the digital assistant because it filters out agents and/or actions that are unlikely to be capable of facilitating the generation of a response to the utterance 202 and/or action performed by the user. This filter ensures that the number of tokens (e.g., word tokens) generated from the input prompt 227 remains under a maximum token limit or context limit set for the LLM 216. Token limits represent the maximum amount of text that can be inputted into an LLM. This limit is of a technical nature and arises due to computational constraints, such as memory and processing resources, and thus makes certain that the LLMs can take the input prompt as input.

In some instances, one or more knowledge actions are additionally appended to the list of candidate agents and the utterance 202. The knowledge actions allow for additional knowledge to be acquired that is pertinent to the utterance 202 and/or action performed by the user (this knowledge is typically outside the scope of the knowledge used to train an LLM of the digital assistant). The are two types of knowledge action sources: (i) structure: the knowledge source defines a list of pre-defined questions that the user might ask and exposes them as some APIs (e.g., Multum), and (ii) unstructured: with the knowledge source, the user has unlimited ways to ask questions and the knowledge source exposes a generic query interface (e.g., medical documents (SOAP notes, discharge summary, etc.)).

In some instances, conversation context 229 concerning the utterance 202 are additionally appended to the list of candidate agents and the utterance 202. The conversation context 229 can be retrievable from one or more sources including the context and memory store 214, and includes user session information, dialog state, conversation or contextual history, application context, page context, user information, or any combination thereof. For example, the conversation context 229 can include: the current date and time, needed to resolve temporal references in user query like “yesterday”, or “next Thursday”, additional context, which contains information such as user profile properties and application context groups with semantic object properties, and the chat history with the digital assistant (and/or other digital assistant or system internal or external to the computing environment 200.

The second step of the two-step approach is for the LLM 216 to generate an execution plan 210 based on the input prompt 227. The LLM 216 can be invoked by creating an LLM chat message with role system passing in the input prompt 227, converting the candidate agents and/or actions into LLM function definitions, retrieving a proper LLM client based on the LLM configuration options, optionally transforming the input prompt 227, LLM chat message, etc. into a proper format for the LLM client, and sending the LLM chat message to the LLM client for invoking the LLM 216. The LLM client then sends back an LLM success response in CLMI format or a provider specific response is converted back to the LLM success response in CLMI format using an adapter such as OpenAIAdapter (or send back or is converted to an LLM error response in case an unexpected error occurred). An LLM call instance is created and added to the conversation history which captures all the request and response details including the execution time.

The LLM 216 has a deep generative model architecture (e.g., a reversible or autoregressive architecture with) for generating the execution plan 210. In some instances, the LLM 216 has over 100 billion parameters and generates the execution plan 210 using autoregressive language modeling within a transformer architecture, allowing the LLM 216 to capture complex patterns and dependencies in the input prompt 227. The LLM's 216 ability to generate the execution plan 210 is a result of its training on diverse and extensive textual data, enabling the LLM to understand human language across a wide range of contexts. During training, the LLM 216 learns to predict the next word in a sequence given the context of the preceding words. This process involves adjusting the model's parameters (weights and biases) based on the errors between its predictions and the actual next words in the training data. When the LLM 216 receives an input such as the input prompt 227, the LLM 216 tokenizes the text into smaller units such as words or sub-words. Each token is then represented as a vector in a high-dimensional space. The LLM 216 processes the input sequence token by token, maintaining an internal representation of context. The LLM's 216 attention mechanism allows it to weigh the importance of different tokens in the context of generating the next word. For each token in the vocabulary, the LLM 216 calculates a probability distribution based on its learned parameters. This probability distribution represents the likelihood of each token being the next word given the context. For example, to generate the execution plan 210, the LLM 216 samples a token from the calculated probability distribution. The sampled token becomes the next word in the generated sequence. This process is repeated iteratively, with each newly generated token influencing the context for generating the subsequent token. The LLM 216 can continue generating tokens until a predefined length or stopping condition is reached.

In some instances, as illustrated in FIG. 2, the LLM 216 may not be able to generate a complete execution plan 210 because it is missing information such as if more information is required to determine an appropriate agent for the response, execute one or more actions, or the like. In this particular instance, the LLM 216 has determine that in order to change the 401k contribution as request by the user, it is necessary to understand whether the user would like to change the contribution by a percentage or certain currency amount. In order to obtain this information, the LLM 216 (or another LLM such as LLM 236) generates end-user response 235 (I'm doing good. Would you like to change your contribution by percentage or amount? [Percentage] [Amount]) to the input prompt 227 that can obtain the missing information such that the LLM 216 is able to generate a complete execution plan 210. In some instances, the response may be rendered within a dialogue box of a UI having one or more UI elements allowing for an easier response by the user. In other instances, the response may be rendered within a dialogue box of a UI allowing for the user to reply using the dialogue box (or alternative means such as a microphone). In this particular instance, the user responds with an additional query 238 (What is my current 401k Contribution? Also, can you tell me the contribution limit?) to gather additional information such that the user can reply to the response 235. The subsequent response-additional query 238—is input into the planner 208 and the same processes described above with respect to utterance 202 are executed but this time with the context of the prior utterances/replies (e.g., utterance 202 and response 235) from the user's conversation with the digital assistant. This time, as illustrated in FIG. 2, the LLM 216 is able to generate a complete execution plan 210 because it has all the information it needs.

In some instances, the utterance 202 by the user may be determined by the LLM 216 to be non-sequitur (i.e., an utterance that does not logically follow from the previous utterance in a dialogue or conversation). In such an instance, an execution plan orchestrator can be used to handle the switch among different dialog paths. The execution plan orchestrator is configured to track all the ongoing conversation paths, create a new entry if a new dialog path is created and pause the current ongoing conversation if any, remove the entry if the conversation completes based on the metadata of the new action or user preference, it might generate a prompt message when starting a non-sequitur or resuming the previous one, manage the dialog for the prompt message and either proceed or restore the current conversation, confirm or cancel when the user responds to the prompt for the non-sequitur. and manages a cancel or exit from a dialog.

The execution plan 210 includes an ordered list of agents and/or actions that can be used and/or executed to sufficiently respond to the request such as the additional query 238. For example, and as illustrated in FIG. 2, the execution plan 210 can be an ordered list that includes a first agent 242a capable of executing a first action 244a via an associated asset and a second agent 242b capable of executing a second action 244b via an associated asset. The agents, and by extension the actions, may be ordered to cause the first action 244a to be executed by the first agent 242a prior to causing the second action 244b to be executed by the second agent 242b. In some instances, the execution plan 210 may be ordered based on dependencies indicated by the agents and/or actions included in the execution plan 210. For example, if executing the second agent 242b is dependent on, or otherwise requires, an output generated by the first agent 242a executing the first action 244a, then the execution plan 210 may order the first agent 242a and the second agent 242b to comply with the dependency. As should be understood, other examples of dependencies are possible.

The execution plan 210 is then transmitted to an execution engine 250 for implementation. The execution engine 250 includes a number of engines, including a natural language-to-programming language translator 252, a knowledge engine 254, an API engine 256, a prompt engine 258, and the like. for executing the actions of agents and implementing the execution plan 210. For example, the natural language-to-programming language translator 252, such as a Conversation to Oracle Meaning Representation Language (C2OMRL) model, may be used by an agent to translate natural language into a intermedial logical for (e.g., OMRL), convert the intermediate logical form into a system programming language (e.g., SQL) and execute the system programming language (e.g., execute an SQL query) on an asset 219 such as data stores 223 to execute actions and/or obtain data or information. The knowledge engine 254 may be used by an agent to obtain data or information from the context and memory store 214 or an asset 219 such as files/documents 222. The API engine 256 may be used by an agent to call an API 220 and interface with an application such as retirement fund account management application to execute actions and/or obtain data or information. The prompt engine 258 may be used by an agent to construct a prompt for input into an LLM such as an LLM in the context and memory store 214 or an asset 219 to execute actions and/or obtain data or information.

The execution engine 250 implements the execution plan 210 by running each agent and executing each action in order based on the ordered list of agents and/or actions using the appropriate engine(s). To facilitate this implementation, the execution engine 250 is communicatively connected (e.g., via a public and/or provue network) with the agents (e.g., 242a, 242b, etc.), the context and memory store 214, and the assets 219. For example, as illustrated in FIG. 2, when the execution engine 250 implements the execution plan 210, it will first execute the agent 242a and action 244a using API engine 256 to call the API 220 and interface with a retirement fund account management application to retrieve the user's current 401k contribution. Subsequently, the execution engine 250 can execute the agent 242b and action 244b using knowledge engine 254 to retrieve knowledge on 401k contribution limits. In some instances, the knowledge is retrieved by knowledge engine 254 from the assets 219 (e.g., files/documents 222). In other instances (as in this particular instance), the knowledge is retrieved by knowledge engine 254 from the context and memory store 214. Knowledge retrieval and action execution using the context and memory store 214 may be implemented using various techniques including internal task mapping and/or machine learning models such as additional LLM models. For example, the query and associated agent for “What is 401k contribution limit” may be mapped to a ‘semantic search’ knowledge task type for searching the indices 213 within the context and memory store 214 for a response to a given query. By way of another example, a request such as “Can you summarize the key points relating to 401k contribution” can be or include a ‘summary’ knowledge task type that may be mapped to a different index within the context and memory store 214 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 214 are optimized to the various task or action types.

The result of implementing the execution plan 210 is output data 269 (e.g., results of actions, data, information, etc.), which is transmitted to an output pipeline 270 for generating end-user responses 272. For example, the output data 269 from the assets 219 (knowledge, API, dialog history, etc.) and relevant information from the context and memory store 214 can be transmitted to the output pipeline 270. The output data 269 is appended to the utterance 202 to construct an output prompt 274 for input to the LLM 236. In some instances, context 229 concerning the utterance 202 are additionally appended to the output data 269 and the utterance 202. The context 229 is retrievable from the context and memory store 214 and includes user session information, dialog state, conversation or contextual history, user information, or any combination thereof. The LLM 236 generates responses 272 based on the output prompt 274. In some instances, the LLM 236 is the same or similar model as LLM 216. In other instances, the LLM 236 different from LLM 216 (e.g., trained on a different set of data, a different architecture, trained for a one or more different tasks, etc.). In either instance, the LLM 236 has a deep generative model architecture (e.g., a reversible or autoregressive architecture with) for generating the responses 272 using similar training and generative processes described above with respect to LLM 216. In some instances, the LLM 236 has over 100 billion parameters and generates the responses 272 using autoregressive language modeling within a transformer architecture, allowing the LLM 236 to capture complex patterns and dependencies in the output prompt 274.

In some instances, the end-user responses 272 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link
attachment: A message with a media URL (file, image, video, or audio)
location: A message with geo-location coordinates
postback: A message with a postback payload
   Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 270 transmits the responses 272 to the end user such as via a user device or interface. In some instances, the responses 272 are rendered within a dialogue box of a GUI allowing for the user to view and reply using the dialogue box (or alternative means such as a microphone). In other instances, the responses 272 are rendered within a dialogue box of a GUI having one or more GUI elements allowing for an easier response by the user. In this particular instance, a first response 272 (What is my current 401k Contribution? Also, can you tell me the contribution limit?) to the additional query 238 is rendered within the dialogue box of a GUI. Additionally, in order to follow-up on obtaining information still required for the initial utterance 202, the LLM 236 generates another response 272 prompting the user for the missing information (Would you like to change your contribution by percentage or amount? [Percentage] [Amount]).

While the embodiment of computing environment 200 in FIG. 2 illustrates the digital assistant interacting in a particular conversation flow, this is not intended to be limiting and is merely provided to facilitate a better understanding of the role and responsibility of the components, services, models, and the like of the computing environment 200 within the conversation flow.

### Block Diagrams for Computing Environments Including a Digital Assistant

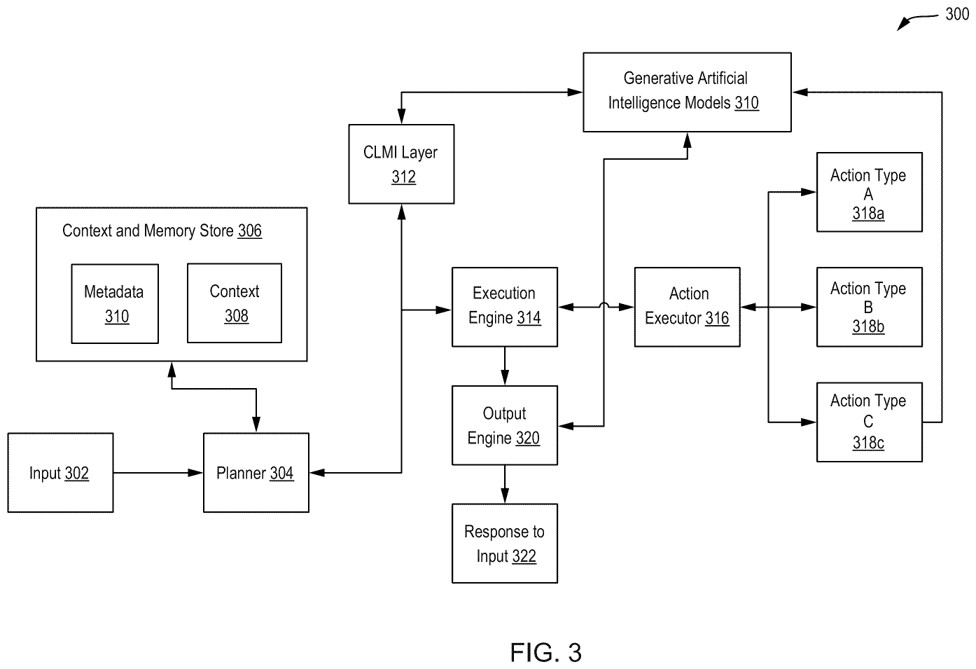

FIG. 3 is a simplified block diagram illustrating processing, by a computing environment (e.g., a computing environment 200 as described with respect to FIG. 2) including a digital assistant 300, for executing an execution plan incorporating contextual information to respond to an utterance from a user in accordance with various embodiments. In some embodiments, the utterance may be provided from the user to the digital assistant 300 via input 302. The input 302 may be or include natural language utterances that can include text input, voice input, image input, or any other suitable input for the digital assistant 300. For example, the input 302 may include text input provided by the user via a keyboard or touchscreen of a computing device used by the user. In other examples, the input 302 may include spoken words provided by the user via a microphone of the computing device. In other examples, the input 302 may include image data, video data, or other media provided by the user via the computing device. Additionally or alternatively, the input 302 may include indications of actions to be performed by the digital assistant 300 on behalf of the user. For example, the input 302 may include an indication that the user wants to order a pizza, that the user wants to update a retirement account contribution, or other suitable indications.

The input 302 is provided to a planner 304 of the digital assistant 300. The planner 304 is a sub-system responsible for choosing one or more appropriate actions given context for a session and/or conversation, and generating the execution plan based on the one or more appropriate actions (with the usage of one or more LLM(s)). In order to choose the one or more appropriate actions, the planner 304 communicates with a context and memory store 306. The context and memory store 306 acts as a single repository for knowledge (short and long-term) acquired and applicable across conversations. The context and memory store 306 provides a mechanism to add and access accumulated knowledge in an efficient way, while hiding the intricacies of the physical layout, storage and indexing aspects. More specifically, the context and memory store 306 acts as a repository for context 308 and metadata 310 for related artifacts to be stored, indexed and be queried reliably. The context and memory store 306 offers a rich and efficient retrieval mechanisms (semantic, indexed search) over the contents (e.g., context 308 and metadata 310), together with lifecycle management, for various applications to build upon.

The metadata 310 provides information for various kinds of artifacts (e.g., assets, context instances, etc.). The context 308 is defined at the session and topic level. A session context acts as a holder for information pertinent to an entire user session, which can include multiple conversations. Session contexts capture user-specific data such as user ID, user preferences, and a summary of prior interactions spanning the sessions. A topic context, which may also be referred to as a conversation context, is more granular and focuses on details relevant to a specific conversation for a given topic within a session. Topic contexts can hold metadata including, but not limited to, unique identifiers of one or more agents or actions, conversation history related to the given topic, user preferences, and transient information stored in a scratchpad. The scratchpad can act as a cache for the context 308 and hold short-term data not backed by a store. The input 302 is synchronously added to the context 308 once received by the planner 304.

The context and memory store 306 is used to identify one or more candidate actions to transmit to the planner 304 based on the input 302. The context and memory store 306 first identifies a topic related to the input 302 by searching a session context or a data store for a list of potential topics and performing a similarity analysis between each potential topic and the input 302. The event of finding a related topic for the input 302 may be referred to as topic resolution. The topic is selected by identifying a topic from the list of topics that meets a threshold confidence level. For example, each potential topic can be assigned a confidence score between 0 and 1 based on a similarity between the potential topic and the input 302, and candidate topics with a positive confidence score greater than the threshold may be selected as the current topic. More than one topic may have a confidence level greater than the threshold and the context and memory store 306 can merge multiple topics into a composite topic. If a topic context for the current topic does not exist, the context and memory store 306 creates a topic context for the identified topic. The input 302 is associated with the topic context. Previous inputs or utterances may have unresolved topic resolution and may be associated with a tentative topic context. The context and memory store can perform topic resolution for the unresolved inputs or can group the previous inputs with the input 302.

After determining a current topic for the input 302, the context and memory store 306 identifies candidate actions for the current topic. The context and memory store 306 searches actions associated with the current topic context instance and/or a data store to identify potential actions and performs a similarity analysis between the input 302, the current context, and the potential action. One or more potential actions that meet a confidence level threshold are selected as candidate actions. The context and memory store 306 retrieves user preferences relevant to the candidate actions to ensure that the interaction is tailored to the user's know preferences and previous interactions. The context and memory store 306 then transmits the user preferences, candidate actions and context 308 to the planner 304.

The planner 304 uses the candidate actions and context 308 to form an input prompt for a generative artificial intelligence model. The generative artificial intelligence model may be or be included in generative artificial intelligence models 310, which may include one or more large language models (LLMs). The planner 304 may be communicatively coupled with the generative artificial intelligence models 310 via a common language model interface layer (CLMI layer 312). The CLMI layer 312 may be an adapter layer that can allow the planner 304 to call a variety of different generative artificial intelligence models that may be included in the generative artificial intelligence models 310. For example, the planner 304 may generate an input prompt and may provide the input prompt to the CLMI layer 312 that can convert the input prompt into a model-specific input prompt for being input into a particular generative artificial intelligence model. The planner 304 may receive output from the particular generative artificial intelligence model that can be used to generate an execution plan. The output may be or include the execution plan. In other embodiments, the output may be used as input by the planner 304 to allow the planner 304 to generate the execution plan. The output may include a list that includes one or more executable actions based on the utterance included in the input 302. In some embodiments, the execution plan may include an ordered list of executable actions embedded with user preferences to execute for addressing the input 302. The execution plan outlines the steps the digital assistant should take to fulfill the user's request. Upon selecting the executable actions and generating the execution plan, the planner 304 modifies the context 308 to include the execution plan.

The planner 304 transmits the context 308 and the execution plan to the execution engine 314 for executing the execution plan. In some embodiments, the execution engine 314 may retrieve the context 308 from the context and memory store 306 if the version received from the planner 304 is determined to be stale. The execution engine can extract the execution plan from the context 308. The execution engine 314 may perform an iterative process for each executable action included in the execution plan. For example, the execution engine 314 may, for each executable action, identify an action type, may invoke one or more states for executing the action type, and may execute the executable action using an asset to obtain an output. The execution engine 314 may be communicatively coupled with an action executor 316 that may be configured to perform at least a portion of the iterative process. For example, the action executor 316 can identify one or more action types for each executable action included in the execution plan. In a particular example, the action executor 316 may identify a first action type 318a for a first executable action of the execution plan. The first action type 318a may be or include a semantic action such as summarizing text or other suitable semantic action.

Additionally or alternatively, the action executor 316 may identify a second action type 318b for a second executable action of the execution plan. The second action type 318b may involve invoking an API such as an API for making an adjustment to an account or other suitable API. Additionally or alternatively, the action executor 316 may identify a third action type 318c for a third executable action of the execution plan. The third action type 318c may be or include a knowledge action such as providing an answer to a technical question or other suitable knowledge action. In some embodiments, the third action type 318c may involve making a call to at least one generative artificial intelligence model of the generative artificial intelligence models 310 to retrieve specific knowledge or a specific answer. In other embodiments, the third action type 318c may involve making a call to the context and memory store 306 or other knowledge documents. During execution, the execution engine 314 continuously updates the context 308 with any new information or results obtained during execution. In some examples, the execution engine 314 can add each prompt, timestamp, and response to the context. The context 308 is synchronized with a durable copy stored in the context and memory store.

The action executor 316 may continue the iterative process based on the action types indicated by the executable actions included in the execution plan. Once the action executor 316 identifies the action types, the action executor 316 may identify and/or invoke one or more states for each executable action based on the action type. A state of an action may involve an indication of if or whether an action can be or has been executed. For example, the state for a particular executable action may include “preparing” “ready” “executing” “success” “failure” or any other suitable states. The action executor 316 can determine, based on the invoked state of the executable action, whether the executable action is ready to be executed, and, if the executable action is not ready to be execute, the action executor 316 can identify missing information or assets required for proceeding with executing the executable action. In response to determining that the executable action is ready to be executed, and in response to determining that no dependencies exist (or existing dependencies are satisfied) for the executable action, the action executor 316 can execute the executable action to generate an output.

The action executor 316 can execute each executable action, or any subset thereof, included in the execution plan to generate a set of outputs. The set of outputs may include knowledge outputs, semantic outputs, API outputs, and other suitable outputs. The action executor 316 may provide the set of outputs to an output engine 320. The output engine 320 may be configured to generate a second input prompt based on the set of outputs. The second input prompt can be provided to at least one generative artificial intelligence model of the generative artificial intelligence models 310 to generate a response 322 to the input 302. The output engine 320 may make a call to the at least one generative artificial intelligence model to cause the at least one generative artificial intelligence model to generate the response 322, which can be provided to the user in response to the input 302. In some embodiments, the at least one generative artificial intelligence model used to generate the response 322 may be similar or identical to, or otherwise the same model, as the at least one generative artificial intelligence model used to generate output for generating the execution plan. The context 308 is updated to include the response 322.

As a particular example, a user wanting to order pizza initiates a session with a digital assistant. “I want to order pizza” is the input 302 provided to the planner 304. The planner 304 retrieves a context 308 from the context and memory store 306 and performs a semantic search to identify actions related to pizza ordering. Based on the context 308, the planner 304 identifies user preferences such as previous orders or favored pizza types. The planner 304 selects the “Order Pizza” action and formulates an execution plan based on the context 308 and the identified user preferences. The planner 304 embeds the execution plan in the context 308 and transmits the execution plan and context 308 to the execution engine. The execution engine 314, which carries out the steps to place the order and updates the context 308 with details such as type of pizza, extra toppings, and the delivery address. The output engine 320 may generate a response 322 informing the user an order has been placed or asking for more information and the context 308 is updated with the response 322. Once the order is confirmed and the conversation ends, the context 308 is finalized and stored in the context and memory store 306 including a summary and relevant metrics for future reference.

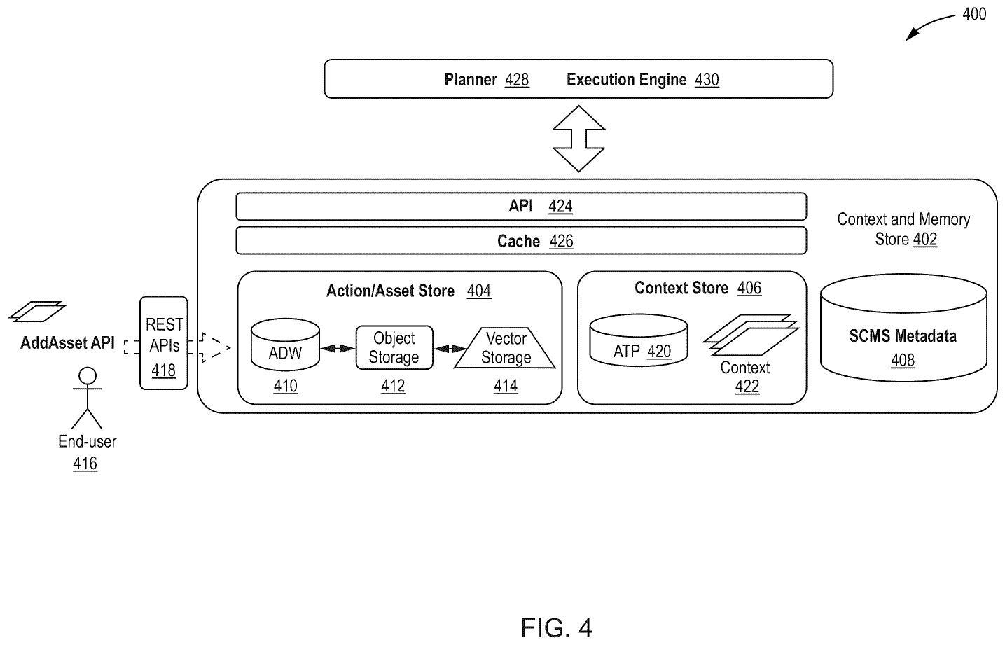

FIG. 4 is a simplified block diagram illustrating a computing environment including a context and memory store 402 (e.g., the context and memory store 306 described with respect to FIG. 3) that can store prior knowledge and contextual information in accordance with various embodiments. The context and memory store 402 operates as a sophisticated infrastructure designed to manage and utilize conversational context and memory in interactions between a user and a digital assistant. The context and memory store 402 can enable digital assistants to handle complex, multi-turn dialogues in a coherent and meaningful manner. More specifically, the context and memory store 402 achieves this by maintaining a repository of knowledge artifacts, context instances, and related indexes, which are important for advanced semantic search capabilities and comprehensive lifecycle management.

Memory within the context and memory store 402 is categorized into short-term and long-term variants. Long-term memory stores persistent knowledge that outlives individual sessions and allows the digital assistant to reference past interactions and user preferences in future sessions. Short-term memory retains information for the duration of a session between a user and a digital assistant, or slightly beyond the completion of a session. Short-term memory handles transient data necessary for ongoing interactions between the user and the digital assistant. A dual memory system between short-term and long-term memory can provide contextually relevant response over time.

The context and memory store 402 is categorized into an asset and action store 404, a context store 406 and a metadata store 408. The asset and action store 404 stores assets, which are indexed and typically stored in vectorized form to be amenable to semantic search. An asset is data that is useful in handling a conversation and can contribute to the knowledge of an action by capturing real-world knowledge and rules. Assets stored in the context and memory store 402 may be similar or identical to assets 219 and can be rich media, including but not limited to documents, audio, images, and video. Assets stored in the context and memory store 402 can be a combination of native assets and virtual assets. Native assets are internal assets that are stored and indexed within the context and memory store 402. Virtual assets are external assets stored outside of the context and memory store 402. The context and memory store 402 may search virtual assets via a search API provided by a search engine hosting the virtual assets. The context and memory store 402 can manage the lifecycle of native assets but may have limited visibility to the lifecycle of virtual assets managed by an external store. An action represents an entity designed to achieve a specific goal that is of interest to a user. An action may be an API, knowledge source, search interface, or digital assistant skill or flow.

The asset and action store 404 includes an object store 412, a vector store 414 and ADW 410. The object store 412 stores assets as raw objects, while the vector store 414 stores assets in vectorized forms to provide advanced semantic and similarity searches. The vector store 414 is a pluggable component that implements a prescribed interface and may be swappable without impact on the rest of the ecosystem. The context and memory store 402 may use a vector store adaptor to interface with pluggable vector stores and act as a layer of indirection between the context memory store 402 and the vector store 414. ADW 410 stores a collection of primitive fields with one or more references to a path in the object store 412.

At design time, an end-user 416 can create and manage a knowledge base by ingesting assets using one or more REST APIs 418 and storing the assets in the asset and action store 404. As an example, the end-user 416 can call an Add Asset API to add one or more assets to the context and memory store 402. Ingesting an asset can involve pre-processing the asset by splitting it into smaller parts, vectorizing the asset and storing it in the vector store 414, summarizing each split, registering metadata for the asset in the metadata store 408, and storing the raw asset along with each split in the object store 412. In some embodiments, assets can be ingested through a bulk export of an external database, or a document upload initiated by the end-user 416 or an enterprise. An action can also be registered with the context and memory store 402 by inputting metadata for the action in the metadata store 408.

The context store 406 holds one or more contexts 422 and an ATP instance 420. The context and memory store 402 is the single source of context instances. A context 422 generally acts as a holder object for metadata and is created naturally at the initiation of an interaction between a user and a digital assistant. The context 422 captures one or more utterances in a conversation between a user and a digital assistant and carries a history of the conversation and metrics regarding a conversation to enable analysis of conversation quality. The context 422 can be a session context or a topic context. A session context holds contextual information about a session between a user and a digital assistant including, but not limited to, a time-ordered set of prior utterances in the session, a summary of a conversation history, and transient information that may not be durable or backed up by a store. A topic context holds contextual information about a conversation between a user and a digital assistant related to a specific topic. A topic context may contain information including, but not limited to, actions involved in the topic conversation, a time-ordered set of prior utterances in the conversation, and virtual pointers to past topic context instances. Contexts are accessible across multiple sessions between a user and a digital assistant. The ATP instance 420 acts a durable store for the context store 406 to persist a context 422 asynchronously. The context and memory store 402 makes asynchronous modifications to a context 422 such as updating a session or conversation summary or updating metrics.

Additionally, the context and memory store 402 auto-computes metadata for offline analysis. The context and memory store 402 manages computation of metrics including but not limited to average latency in bot-response, duration of interaction, and user sentiment. The context and memory store 402 manages summarization of long-running sessions or conversations by invoking one or more LLMs asynchronously without blocking a user. Upon the end of a session or a conversation, the corresponding context is marked as immutable and processed by the context and memory store 402 to update the conversation or session summary and metrics. The process may be referred to as finalization. No additional updates occur after finalization and the context object is routed for eventual storage outside the context and memory store 402. The context and memory store 402 may retain copies of finalized context to enable continued metadata and quality analysis.

The context and memory store 402 hides the intricacies of the internal physical layout, storage, and indexing. The context and memory store 402 can have one or more APIs 424 to facilitate queries to the context and memory store 402 (e.g. by the planner 428, the execution engine 430). An entity interfacing with the context and memory store 402 using the APIs 424 may not be aware of the physical layout, storage and indexing aspects of the context and memory store 402. In some embodiments, queries to the context and memory store 402 may be made using one or more SDKs or CLI instead of or in addition to the one or more APIs 424. The context and memory store contains a distributed write-through cache 426 offering efficient access to artifacts stored within the context and memory store 402 in response to a call to the API 424. Updates to contexts by components outside the context and memory store 402 (e.g. planner 428) are reflected in the cache 426 and persisted into durable storage in the context store 408.

In some embodiments, the context and memory store 402 may make decisions on optimal retrieval of assets from the asset and action store 404. For example, retrieval of a virtual asset from the asset and action store 404 may take more time or may be more costly than retrieval of a native asset because the context and memory store 402 accesses an external search API to retrieve virtual assets. In such examples, the context and memory store 402 makes an optimization decision to determine which asset to retrieve.

In some embodiments, the context and memory store 402 can proactively prepare or gather assets or knowledge for the user based on the context 422. The context and memory 402 may use contextual information from one or more context instances to predict a user's possible future intent without any explicit request or input by a user and make smart queries to the knowledge base for information that may aid in the conversation. The context and memory store 402 accesses a user preferences interface to determine a user's preferences in relation to the context 422 and establish a user's affinity towards certain goals. For example, a user may ask a digital assistant about 401k contributions. The context and memory store 402 may determine, based on previous utterances and one or more context instances, that the user may ask a question about contributing to a Roth IRA and subsequently gather assets related to Roth IRA contributions. In some examples, the context and memory store 402 may also preemptively create action plans for a planner based on the context 422.

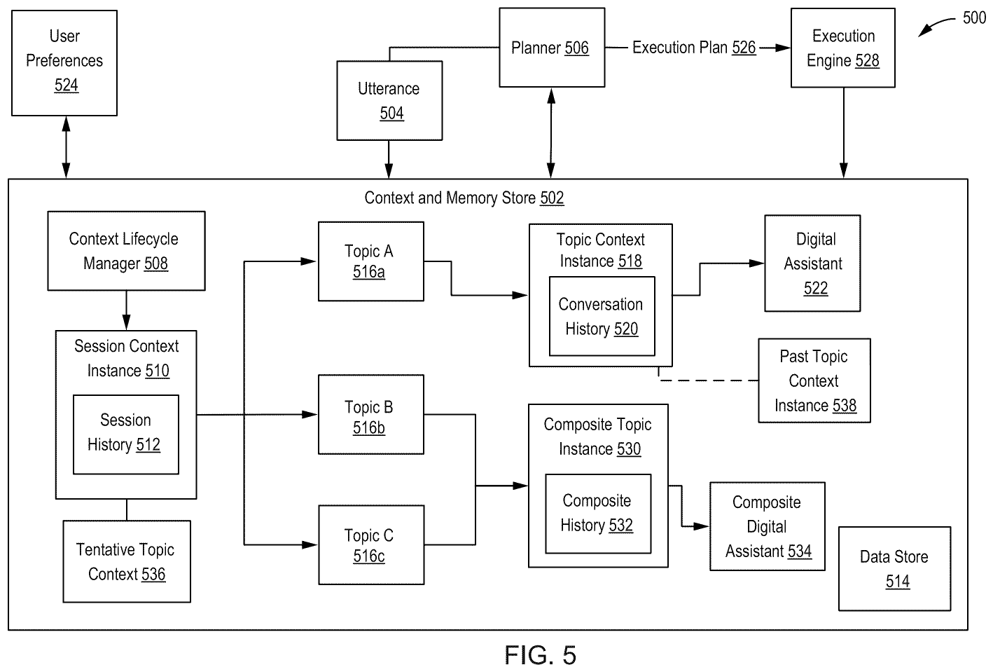

FIG. 5 is a simplified block diagram illustrating data flows for managing contextual information surrounding a user's interactions with a digital assistant using a context and memory store (e.g., the context and memory store 402 described with respect to FIG. 4) in accordance with various embodiments. In some embodiments, the context and memory store 502 can receive a natural language utterance 504 from a planner 506 during a session between a user and the digital assistant. The planner 506 may be or may utilize one or more generative language models. The context and memory store 502 contains a context lifecycle manager 508 that manages the lifecycle of a context including but not limited to creation, modification, synchronization, finalization and expiration. In some embodiments, a context may be implemented as a class that defines shared aspects between all instances of the class. Each instance is a specific object or occurrence of the class and can have a shared definition of variables and methods but represent different states or values. As an example, one context instance can represent a particular conversation between a user and a digital assistant about a topic and hold information specific to that particular conversation for fields defined by a topic context class. As another example, a session context instance can represent a particular session and hold information specific to the session for fields defined by a session context class.

At the onset of a session between a user and a digital assistant, the context lifecycle manager 508 can create a session context instance 510. In some examples, a session can be a follow up from a past user interaction and the session context instance 510 is populated with relevant information from the past user interaction. The past user interaction can be retrieved using a user ID and can be restricted to a bounded time window from the past. The session context instance 510 retains a session history 512 of the conversation between the user and digital assistant during the current session and contains searchable links to previous conversation history and potential topics.

For the utterance 504 received, the context and memory store 502 performs topic resolution to determine a topic related to the utterance 504 and obtains a topic context instance. A topic (e.g., assistance with managing a 401k contribution or ordering a pizza) is predefined to correlate with possible actions the digital assistant may execute. In some instances, a topic may be a combination of one or more topics related to separate digital assistants. The context and memory store 502 searches the session context instance 512, a data store 514, or a combination thereof, for potential topics. As an example, the current session context instance 512 may have a set of possible topics including topic 516a, topic 516b, and topic 516c. The context and memory store 502 determines a confidence score for one or more candidate topics and determines a threshold for a confidence score to select a topic as the current session topic. For example, all possible topics may receive a confidence score between 0 and 1 based on the similarity between the utterance and a topic. A threshold of 0.7 may be set and a topic with a confidence score greater than 0.7 may be selected as the current topic. As an example, topic 516a may be determined to have a confidence score greater than 0.7. The context lifecycle manager 508 can create a topic context instance 518 linked to topic 516a.

The identified topic is associated with a topic context instance 518 and is marked as active. A session may have multiple ongoing conversation, but only one may be marked active. In some examples, the context lifecycle manager 508 may create the topic context instance 518 linked to topic 510a if it does not already exist. The topic context instance 518 can hold a conversation history 520 between the user and a digital assistant associated with topic 516a. The conversation history 520 may also be included in the session history 512 held in the session context instance 510. The session history 512 may include additional conversation history between the user and one or more digital assistants that may not be included in conversation history 520.

The context and memory store 502 performs action resolution to generate a list of one or more candidate actions related to the utterance 504 and current topic. The topic context instance 518 may be associated with a digital assistant 522 with a set of predefined actions. Additionally or alternatively, the context and memory store 502 may search the data store 514 to identify potential actions. As an example, a topic context instance representing a 401k topic may be associated with a set of actions including changing 401k contributions amounts. In some embodiments, each action associated with a topic context instance may be initialized with a confidence score of 0. Actions with a confidence score of 0 may be referred to as potential actions. The context and memory store 502 performs a similarity analysis between the utterance 504 and each potential action to determine an updated confidence score. Potential actions determined to have a nonzero confidence score are referred to as candidate actions. The context and memory store 502 retrieves user preferences 524 from a User Profile and Preference service to ensure the generated candidate actions are tailored to the user's known preferences and past interactions. The context and memory store 502 may set a threshold for determining executable actions. In some examples, a threshold of 0.7 may be set and candidate actions with a confidence score greater than 0.7 may be selected as executable actions.

The context and memory store 502 transmits the list of candidate actions and a context containing the current session and topic information to the planner 506, which may be or may make use of one or more LLMs. The planner 506 may use contextual information from one or more context instances and the list of candidate actions to determine a list of executable actions. The planner 506 determines one or more executable actions by performing a similarity analysis between a candidate action, the utterance 504, and contextual information from one or more context instances. The planner 506 creates and transmits an execution plan 526 including one or more executable actions to an execution engine 528 and updates the topic context instance 518 to include the execution plan 526. Upon execution, the execution engine 528 updates the topic context instance 518 to include a result of an execution.

In some examples, multiple topics may have a confidence score greater than the selected threshold for similarity between a topic and the utterance 504. The context and memory store 502 can merge multiple topics to create a composite topic context instance. As an example, topic 516b and topic 516c may both have a confidence score greater than a selected threshold. The context and memory store 502 may merge the topic 516b and topic 516c to create a composite topic context instance 530. The composite topic context instance 530 can hold a composite history 532 contain conversation history relating to topic 516b and topic 516c. The composite topic context instance 530 may be linked to a composite digital assistant 534. The composite digital assistant 534 may be associated a set of potential actions associated with topic 516b and topic 516c respectively. The context and memory store 502 may perform action resolution by selecting actions associated with the composite topic instance 530.

In some examples, the context and memory store 502 may be unable to associate the utterance 504 with a topic. In some examples, all candidate topics may have a confidence level less than the determined threshold for candidate topics. The context lifecycle manager 504 can create a tentative topic context 536 and the utterance 504 may be associated with the tentative topic context 536. The context and memory store 502 can receive one or more subsequent utterance after the utterance 504 and perform topic resolution on the subsequent utterances to identify an associated topic with the subsequent utterance. In some examples, the context and memory store 502 may perform a topic resolution on the utterance 504 again and associate the utterance 504 with the same or different topic as the subsequent utterance. In some examples, the context and memory store 502 may still be unable to associate the utterance 504 with a topic context and the utterance 504 remains associated with the tentative topic context 536. In other examples, the utterance 504 may be grouped with one or more subsequent utterances and the context and memory store 502 may identify a topic for the group of utterances.

In some instances, a user may reference a previous conversation in the utterance 504. The context and memory store 500 can search the session context instance 510 and/or the data store 514 for a past topic context instance 538 that matches the utterance 504. The past topic context instance 538 contains information about a past interaction between the user and the digital assistant. The past topic context instance 538 is linked to the current topic context instance 518 using a virtual pointer to provide quick access to previous utterances and executed actions.

### Flowchart for Responding to a Query Using Context

FIG. 6 is a flowchart of a process 600 for responding to a query using knowledge information (e.g., context) from a context and memory store in accordance with various embodiments. The processing depicted in FIG. 6 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 6 and described below is intended to be illustrative and non-limiting. Although FIG. 6 illustrates the various processing steps occurring in a particular sequence or order, this is not intended to be limiting. In certain alternative embodiments, the steps may be performed in some different order or some steps may also be performed at least partially in parallel. In certain embodiments, the processing depicted in FIG. 6 may be performed by one or more of the components, computing devices, services, or the like, such as the digital assistant, the generative artificial intelligence model (LLMs), the context and memory store, etc., illustrated and described with respect to FIGS. 1-5.

At step 605, a natural language utterance from a user during a session between the user and a digital assistant is received at the digital assistant. In some instances, a subsequent natural language utterance or another subsequent natural language utterance can be received after the natural language utterance (e.g., natural language utterances received in a conversation after an initial natural language utterance that starts the conversation (within a same or different session)). In some instances, the natural language utterance may be a subsequent natural language utterance or another subsequent natural language utterance. In some instances, the natural language utterance may reference a prior conversation between the user and the digital assistant.

In some instances, prior to receiving the natural language utterance, a current session context instance for the session is created in response to a user logging into an application associated with the digital assistant. The current session context instance can comprise prior natural language utterances from the user during the session between the user and the digital assistant. Each of the prior natural language utterances may be (a) resolved and associated with the topic context instance or other topic context instance associated with the current session context instance or (b) unresolved and associated with a tentative topic context instance.

At step 610, a topic context instance for the natural language utterance is obtained. Obtaining a topic context instance can comprise: executing, based on the natural language, a search on a current session context instance, a data store, or both; based on the search, determining whether the natural language utterance satisfies a threshold level of similarity with one or more topics represented in the current session context instance, the data store, or both; responsive to determining the natural language utterance satisfies the threshold level of similarity with the one or more topics, identifying the topic context instance associated with the one or more topics; and associating the natural language utterance with the topic context instance.

In some instances, the digital assistant is configured to handle a plurality of actions associated with a plurality of topics including the one or more topics. In some instances, the topic context instance is specific to the one or more topics and is associated with one or more actions of the plurality of actions. In some instances, determining whether the natural language utterance satisfies the threshold level of similarity with the one or more topics is a function of similarity between the natural language utterance and the associated one or more actions.

In some instances, a subsequent natural language utterance is received at the digital assistant from the user during the session between the user and the digital assistant. In such an instance, a tentative topic context instance for a subsequent natural language utterance can be obtained. Obtaining the tentative topic context instance for the subsequent natural language utterance comprises: executing a search on the current session context instance, the data store, or both, based on the subsequent natural language occurrence; based on the search, determining the subsequent natural language utterance does not satisfy the threshold level of similarity with one or more topics represented in the current session context instance, the data store, or both; responsive to determining the subsequent natural language utterance does not satisfy the threshold level of similarity with the one or more topics, creating the tentative topic context instance associated with the current session context instance; and associating the subsequent natural language utterance with the tentative topic context instance.

In some instances, another subsequent natural language utterance is received at the digital assistant from the user during the session between the user and the digital assistant. In such an instance, a tentative topic context instance for a subsequent natural language utterance can be obtained. Obtaining the tentative topic context instance for the subsequent natural language utterance comprises: executing, based on the another subsequent natural language utterance, a search on the current session context instance, the data store, or both; based on the search, determining the another subsequent natural language utterance satisfies the threshold level of similarity with the same or different one or more topics represented in the current session context instance, the data store, or both; responsive to determining the another subsequent natural language utterance satisfies the threshold level of similarity with the same or different one or more topics, identifying the same or different topic context instance associated with the same or different one or more topics; and associating the another subsequent natural language utterance with the same or different topic context instance.

In some instances, the subsequent natural language utterance associated with the tentative topic context instance is reevaluated in response to receiving the another subsequent natural language utterance from the user. In some instances, reevaluating the subsequent natural language comprises: executing, based on the subsequent natural language utterance, a search on the current session context instance, the data store, or both; based on the search, determining the subsequent natural language utterance satisfies the threshold level of similarity with the same or different one or more topics represented in the current session context instance, the data store, or both; responsive to determining the subsequent natural language utterance satisfies the threshold level of similarity with the same or different one or more topics, identifying the same or different topic context instance associated with the same or different one or more topics; and associating the subsequent natural language utterance with the same or different topic context instance.

In some instances, obtaining the topic context instance for the natural language utterance further comprises based on the reference to the prior conversation and the search, identifying a past topic context instance associated with the same or different one or more topics. In some instances, obtaining the topic context instance for the natural language utterance further comprises linking, using a virtual pointer, the topic context instance with the past topic context instance.

In some instances, multiple topic context instances associated with the current session context instance and associated with the one or more topics are identified in response to determining the natural language utterance satisfies the threshold level of similarity with the one or more topics. In some instances, obtaining the topic context instance for the natural language utterance further comprises merging multiple topic context instances to create the topic context instance as a composite of multiple topic context instances.

In some instances, the context within the topic context instance includes a conversation history between the user and the digital assistant; the context within each of the multiple topic context instances includes additional conversation history between the user and the digital assistant; and merging the multiple topic context instances includes concatenating the conversation history with each of the additional conversation histories.

In some instances, the context within the topic context instance includes a conversation history between the user and the digital assistant; and the current session context instance is associated with the topic context instance and one or more other topic context instances, each of the one or more other topic context instances includes additional conversation history between the user and the digital assistant.

In some instances, a summary of the conversation history and the additional conversation history between the user and the digital assistant is generated. The current session context instance is revised to include the summary of the conversation history and performance metrics for the digital assistant based on the revised current session context instance are computed.

At step 615, a list comprising one or more executable actions based on one or more candidate actions associated with the topic context instance is generated by a first generative artificial intelligence model. In some instances, the list is generated by selecting the one or more executable actions from the one or more candidate actions based on each of the one or more executable actions satisfying a threshold level of similarity with the natural language utterance and context within the topic context instance.

In some instances, the one or more candidate actions are identified as being associated with the topic context instance by executing, using the natural language utterance, a semantic search of potential actions represented in the data store that are associated with the digital assistant. In some instances, the potential actions have a zero-confidence level for satisfying the threshold level of similarity with the natural language utterance and the context within the topic context instance; the one or more candidate actions have a positive confidence level for satisfying the threshold level of similarity with the natural language utterance and the context within the topic context instance; and the one or more executable actions have a positive confidence level and do satisfy the threshold level of similarity with the natural language utterance and the context within the topic context instance, based on which the first generative artificial intelligence model predicts that the one or more executable actions are relevant for responding to the natural language utterance with a high confidence level.

In some instances, an input prompt comprising the one or more candidate actions, at least a portion of the context associated with the topic context instance, and the natural language utterances is constructed based on the topic context instances. In some instances, the input prompt to the first generative artificial intelligence model is provided, where the first generative artificial intelligence model generates the list comprising the executable action based on the input prompt.

In some instances, the one or more executable actions are selected from the one or more candidate actions based on each of the one or more executable actions satisfying the threshold level of similarity with the natural language utterance, the context within the topic context instance, and additional context within the past topic context instance.

At step 620, an execution plan comprising the one or more executable actions is created based on the list.

In some instances, a search on user-preferences in the data store is executed based on the one or more candidate actions to identify one or more user-preferences that are relevant to the one or more candidate actions. In some instances, creating the execution plan comprises embedding the one or more user-preferences into the execution plan.

At step 625, an updated topic context instance is generated by updating the topic context instance to include the execution plan.

At step 630, the execution plan based on the updated topic context instance is executed, where the executing comprises executing the executable action using an asset to obtain an output.

In some instances, based on the output and the topic context instance, an input prompt comprising the output, at least a portion of the context associated with the topic context instance, and the natural language utterance is constructed. In some instances, the input prompt is provided to a second generative artificial intelligence model. The second generative artificial intelligence model is a same or different model from that of the first generative artificial intelligence model.

At step 635, the output or communication derived from the output is sent to the user.

In some instances, a response to the natural language utterance is generated by the second generative artificial intelligence model based on the input prompt. The response can be the communication derived from the output.

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

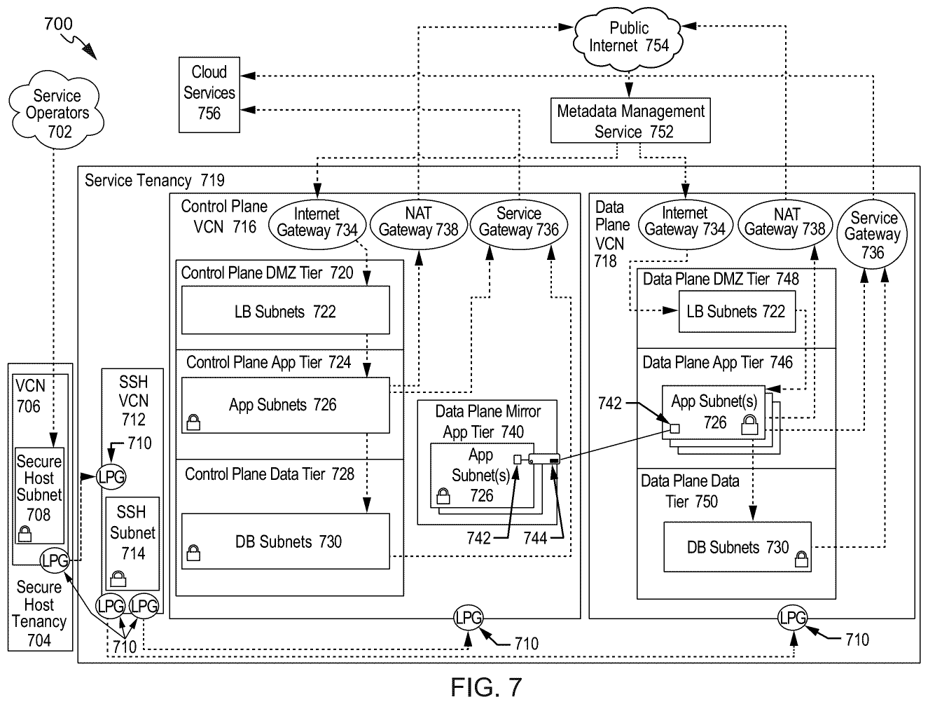

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 606 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 616 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Metadata that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of threat prevention, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

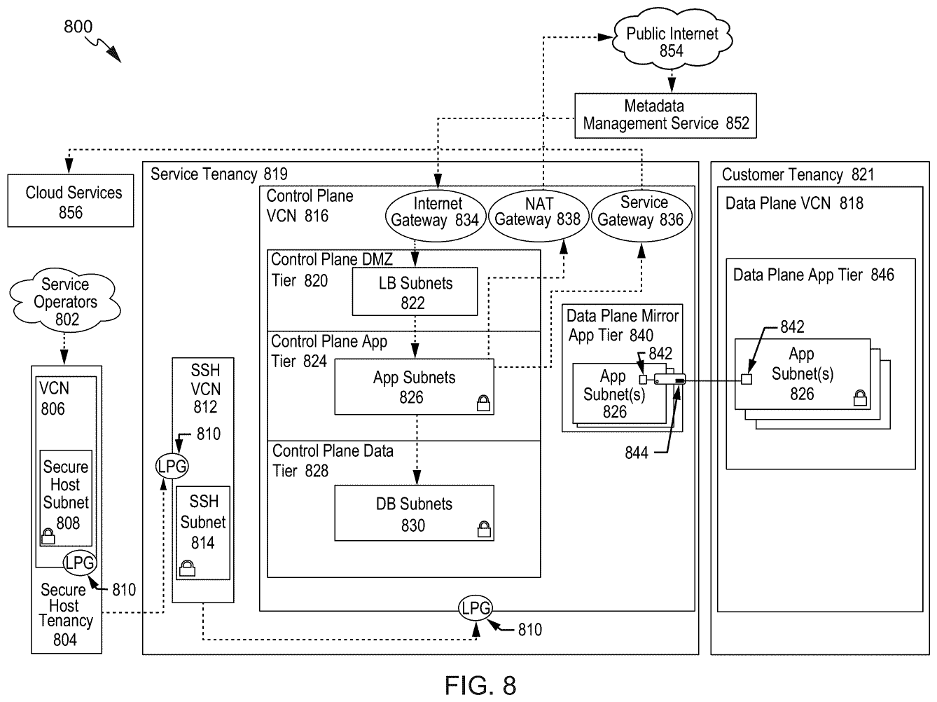

FIG. 8 is a block diagram 800 illustrating another example pattern of an IaaS architecture, according to at least one embodiment. Service operators 802 (e.g., service operators 702 of FIG. 7) can be communicatively coupled to a secure host tenancy 804 (e.g., the secure host tenancy 704 of FIG. 7) that can include a virtual cloud network (VCN) 806 (e.g., the VCN 706 of FIG. 7) and a secure host subnet 808 (e.g., the secure host subnet 708 of FIG. 7). The VCN 806 can include a local peering gateway (LPG) 810 (e.g., the LPG 710 of FIG. 7) that can be communicatively coupled to a secure shell (SSH) VCN 812 (e.g., the SSH VCN 712 of FIG. 7) via an LPG 610 contained in the SSH VCN 812. The SSH VCN 812 can include an SSH subnet 814 (e.g., the SSH subnet 714 of FIG. 7), and the SSH VCN 812 can be communicatively coupled to a control plane VCN 816 (e.g., the control plane VCN 716 of FIG. 7) via an LPG 810 contained in the control plane VCN 816. The control plane VCN 816 can be contained in a service tenancy 819 (e.g., the service tenancy 719 of FIG. 7), and the data plane VCN 818 (e.g., the data plane VCN 718 of FIG. 7) can be contained in a customer tenancy 821 that may be owned or operated by users, or customers, of the system.

The control plane VCN 816 can include a control plane DMZ tier 820 (e.g., the control plane DMZ tier 720 of FIG. 7) that can include LB subnet(s) 822 (e.g., LB subnet(s) 722 of FIG. 7), a control plane app tier 824 (e.g., the control plane app tier 724 of FIG. 7) that can include app subnet(s) 826 (e.g., app subnet(s) 726 of FIG. 7), a control plane data tier 828 (e.g., the control plane data tier 728 of FIG. 7) that can include database (DB) subnet(s) 830 (e.g., similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g., the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g., the service gateway 736 of FIG. 7) and a network address translation (NAT) gateway 838 (e.g., the NAT gateway 738 of FIG. 7). The control plane VCN 816 can include the service gateway 836 and the NAT gateway 838.

The control plane VCN 816 can include a data plane mirror app tier 840 (e.g., the data plane mirror app tier 740 of FIG. 7) that can include app subnet(s) 826. The app subnet(s) 826 contained in the data plane mirror app tier 840 can include a virtual network interface controller (VNIC) 842 (e.g., the VNIC of 742) that can execute a compute instance 844 (e.g., similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g., the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g., the metadata management service 752 of FIG. 7) that can be communicatively coupled to public Internet 854 (e.g., public Internet 754 of FIG. 7). Public Internet 854 can be communicatively coupled to the NAT gateway 838 contained in the control plane VCN 816. The service gateway 836 contained in the control plane VCN 816 can be communicatively coupled to cloud services 856 (e.g., cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818 but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 6,” may be located in Region 1 and in “Region 2.” If a call to Deployment 6 is made by the service gateway 836 contained in the control plane VCN 816 located in Region 1, the call may be transmitted to Deployment 6 in Region 1. In this example, the control plane VCN 816, or Deployment 6 in Region 1, may not be communicatively coupled to, or otherwise in communication with, Deployment 6 in Region 2.

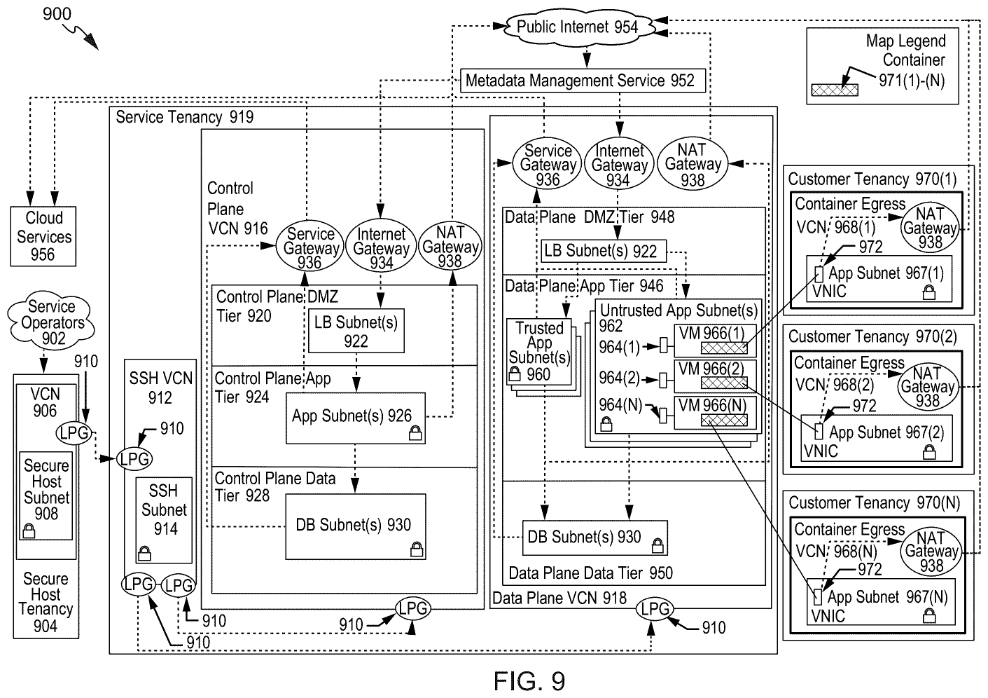

FIG. 9 is a block diagram 900 illustrating another example pattern of an IaaS architecture, according to at least one embodiment. Service operators 902 (e.g., service operators 702 of FIG. 7) can be communicatively coupled to a secure host tenancy 904 (e.g., the secure host tenancy 704 of FIG. 7) that can include a virtual cloud network (VCN) 906 (e.g., the VCN 706 of FIG. 7) and a secure host subnet 908 (e.g., the secure host subnet 708 of FIG. 7). The VCN 906 can include an LPG 910 (e.g., the LPG 710 of FIG. 7) that can be communicatively coupled to an SSH VCN 912 (e.g., the SSH VCN 712 of FIG. 7) via an LPG 910 contained in the SSH VCN 912. The SSH VCN 912 can include an SSH subnet 914 (e.g., the SSH subnet 714 of FIG. 7), and the SSH VCN 912 can be communicatively coupled to a control plane VCN 916 (e.g., the control plane VCN 716 of FIG. 7) via an LPG 910 contained in the control plane VCN 916 and to a data plane VCN 918 (e.g., the data plane 718 of FIG. 7) via an LPG 910 contained in the data plane VCN 918. The control plane VCN 916 and the data plane VCN 918 can be contained in a service tenancy 919 (e.g., the service tenancy 719 of FIG. 7).

The control plane VCN 916 can include a control plane DMZ tier 920 (e.g., the control plane DMZ tier 720 of FIG. 7) that can include load balancer (LB) subnet(s) 922 (e.g., LB subnet(s) 722 of FIG. 7), a control plane app tier 924 (e.g., the control plane app tier 724 of FIG. 7) that can include app subnet(s) 926 (e.g., similar to app subnet(s) 726 of FIG. 7), a control plane data tier 928 (e.g., the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g., the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g., the service gateway of FIG. 7) and a network address translation (NAT) gateway 938 (e.g., the NAT gateway 738 of FIG. 7). The control plane VCN 916 can include the service gateway 836 and the NAT gateway 938.

The data plane VCN 918 can include a data plane app tier 946 (e.g., the data plane app tier 746 of FIG. 7), a data plane DMZ tier 948 (e.g., the data plane DMZ tier 748 of FIG. 7), and a data plane data tier 950 (e.g., the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g., public Internet 754 of FIG. 7).

The Internet gateway 934 contained in the control plane VCN 916 and contained in the data plane VCN 918 can be communicatively coupled to a metadata management service 952 (e.g., the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively coupled to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

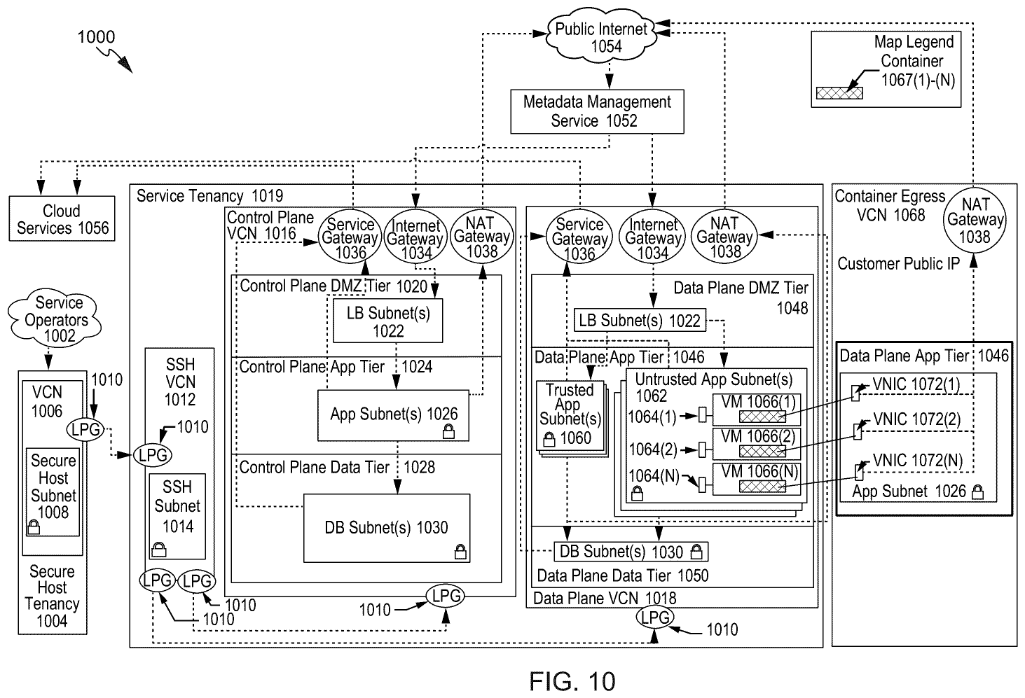

FIG. 10 is a block diagram 1000 illustrating another example pattern of an IaaS architecture, according to at least one embodiment. Service operators 1002 (e.g., service operators 702 of FIG. 7) can be communicatively coupled to a secure host tenancy 1004 (e.g., the secure host tenancy 704 of FIG. 7) that can include a virtual cloud network (VCN) 1006 (e.g., the VCN 706 of FIG. 7) and a secure host subnet 1008 (e.g., the secure host subnet 708 of FIG. 7). The VCN 1006 can include an LPG 1010 (e.g., the LPG 710 of FIG. 7) that can be communicatively coupled to an SSH VCN 1012 (e.g., the SSH VCN 712 of FIG. 7) via an LPG 1010 contained in the SSH VCN 1012. The SSH VCN 1012 can include an SSH subnet 1014 (e.g., the SSH subnet 714 of FIG. 7), and the SSH VCN 1012 can be communicatively coupled to a control plane VCN 1016 (e.g., the control plane VCN 716 of FIG. 7) via an LPG 1010 contained in the control plane VCN 1016 and to a data plane VCN 1018 (e.g., the data plane 718 of FIG. 7) via an LPG 1010 contained in the data plane VCN 1018. The control plane VCN 1016 and the data plane VCN 1018 can be contained in a service tenancy 1019 (e.g., the service tenancy 719 of FIG. 7).

The control plane VCN 1016 can include a control plane DMZ tier 1020 (e.g., the control plane DMZ tier 720 of FIG. 7) that can include LB subnet(s) 1022 (e.g., LB subnet(s) 722 of FIG. 7), a control plane app tier 1024 (e.g., the control plane app tier 724 of FIG. 7) that can include app subnet(s) 1026 (e.g., app subnet(s) 726 of FIG. 7), a control plane data tier 1028 (e.g., the control plane data tier 728 of FIG. 7) that can include DB subnet(s) 1030 (e.g., DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g., the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g., the service gateway of FIG. 7) and a network address translation (NAT) gateway 1038 (e.g., the NAT gateway 738 of FIG. 7). The control plane VCN 1016 can include the service gateway 1036 and the NAT gateway 1038.

The data plane VCN 1018 can include a data plane app tier 1046 (e.g., the data plane app tier 746 of FIG. 7), a data plane DMZ tier 1048 (e.g., the data plane DMZ tier 748 of FIG. 7), and a data plane data tier 1050 (e.g., the data plane data tier 750 of FIG. 7). The data plane DMZ tier 1048 can include LB subnet(s) 1022 that can be communicatively coupled to trusted app subnet(s) 1060 (e.g., trusted app subnet(s) 960 of FIG. 9) and untrusted app subnet(s) 962 (e.g., untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g., public Internet 754 of FIG. 7).

The Internet gateway 1034 contained in the control plane VCN 1016 and contained in the data plane VCN 1018 can be communicatively coupled to a metadata management service 1052 (e.g., the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively coupled to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

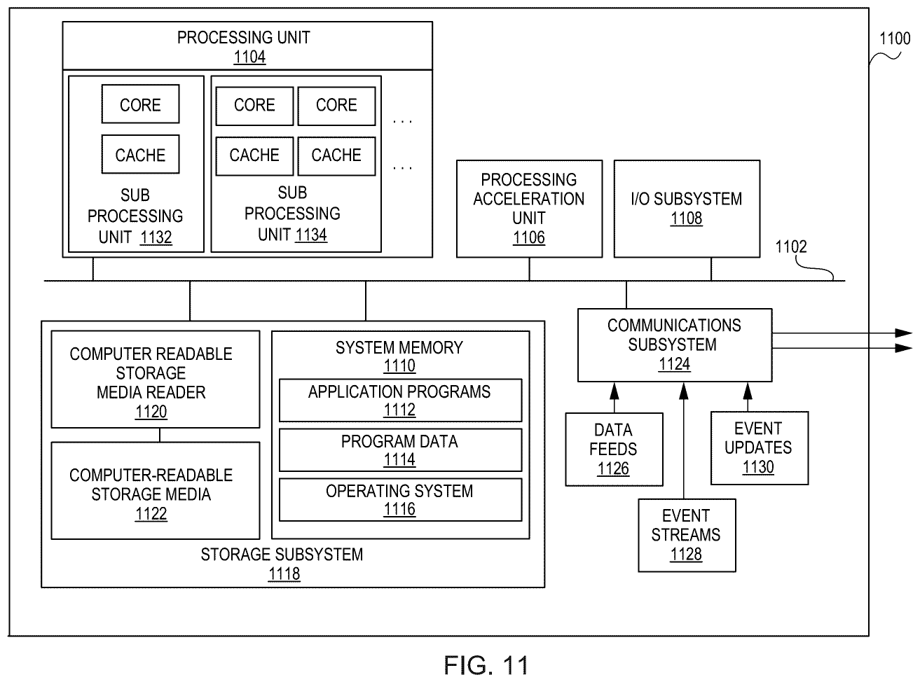

FIG. 11 illustrates an example computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1104 provide the functionality described above. Storage subsystem 1118 may also provide a repository for storing data used in accordance with the present disclosure.

As depicted in the example in FIG. 11, storage subsystem 1118 can include various components including a system memory 1110, computer-readable storage media 1122, and a computer readable storage media reader 1120. System memory 1110 may store program instructions that are loadable and executable by processing unit 1104. System memory 1110 may also store data that is used during the execution of the instructions and/or data that is generated during the execution of the program instructions. Various different kinds of programs may be loaded into system memory 1110 including but not limited to client applications, Web browsers, mid-tier applications, relational database management systems (RDBMS), virtual machines, containers, etc.

System memory 1110 may also store an operating system 1116. Examples of operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1100 executes one or more virtual machines, the virtual machines along with their guest operating systems (GOSs) may be loaded into system memory 1110 and executed by one or more processors or cores of processing unit 1104.

System memory 1110 can come in different configurations depending upon the type of computer system 1100. For example, system memory 1110 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1110 may include a basic input/output system (BIOS) containing basic routines that help to transfer information between elements within computer system 1100, such as during start-up.

Computer-readable storage media 1122 may represent remote, local, fixed, and/or removable storage devices plus storage media for temporarily and/or more permanently containing, storing, computer-readable information for use by computer system 1100 including instructions executable by processing unit 1104 of computer system 1100.

Computer-readable storage media 1122 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Machine-readable instructions executable by one or more processors or cores of processing unit 1104 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer-implemented method comprising:
receiving, at a digital assistant, a natural language utterance from a user during a session between the user and the digital assistant;
obtaining a topic context instance for the natural language utterance, wherein the obtaining comprises:
executing, based on the natural language utterance, a search on a current session context instance, a data store, or both,
based on the search, determining whether the natural language utterance satisfies a threshold level of similarity with one or more topics represented in the current session context instance, the data store, or both,
responsive to determining the natural language utterance satisfies the threshold level of similarity with the one or more topics, identifying the topic context instance associated with the one or more topics, and
associating the natural language utterance with the topic context instance;
generating, by a first generative artificial intelligence model, a list comprising one or more executable actions based on one or more candidate actions associated with the topic context instance;
creating, based on the list, an execution plan comprising the one or more executable actions;
generating an updated topic context instance by updating the topic context instance to include the execution plan;
executing the execution plan based on the updated topic context instance, wherein the executing comprises executing the executable action using an asset to obtain an output; and
sending the output or a communication derived from the output to the user.

2. The computer-implemented method of claim 1, wherein generating the list comprises selecting the one or more executable actions from the one or more candidate actions based on each of the one or more executable actions satisfying a threshold level of similarity with the natural language utterance and context within the topic context instance.

3. The computer-implemented method of claim 1 further comprising:
responsive to a user logging into an application associated with the digital assistant, creating the current session context instance for the session,
wherein the current session context instance comprises prior natural language utterances from the user during the session between the user and the digital assistant, and wherein each of the prior natural language utterances (a) is resolved and associated with the topic context instance or other topic context instance associated with the current session context instance or (b) is unresolved and associated with a tentative topic context instance.

4. The computer-implemented method of claim 1, wherein:
the digital assistant is configured to handle a plurality of actions associated with a plurality of topics including the one or more topics;
the topic context instance is specific to the one or more topics and is associated one or more actions of the plurality of actions; and
determining whether the natural language utterance satisfies the threshold level of similarity with the one or more topics is a function of similarity between the natural language utterance and the associated one or more actions.

5. The computer-implemented method of claim 1, further comprising:
receiving, at the digital assistant, a subsequent natural language utterance from the user during the session between the user and the digital assistant;
obtaining a tentative topic context instance for the subsequent natural language utterance, wherein the obtaining comprises:
executing, based on the subsequent natural language utterance, a search on the current session context instance, the data store, or both,
based on the search, determining the subsequent natural language utterance does not satisfy the threshold level of similarity with one or more topics represented in the current session context instance, the data store, or both,
responsive to determining the subsequent natural language utterance does not satisfy the threshold level of similarity with the one or more topics, creating the tentative topic context instance associated with the current session context instance, and
associating the subsequent natural language utterance with the tentative topic context instance.

6. The computer-implemented method of claim 5, further comprising:
receiving, at the digital assistant, another subsequent natural language utterance from the user during the session between the user and the digital assistant;
obtaining the topic context instance for the another subsequent natural language utterance, wherein the obtaining comprises:
executing, based on the another subsequent natural language utterance, a search on the current session context instance, the data store, or both,
based on the search, determining the another subsequent natural language utterance satisfies the threshold level of similarity with the same or different one or more topics represented in the current session context instance, the data store, or both,
responsive to determining the another subsequent natural language utterance satisfies the threshold level of similarity with the same or different one or more topics, identifying the same or different topic context instance associated with the same or different one or more topics, and
associating the another subsequent natural language utterance with the same or different topic context instance.

7. The computer-implemented method of claim 6, further comprising:
responsive to receiving the another subsequent natural language utterance from the user, reevaluating the subsequent natural language utterance associated with the tentative topic context instance, wherein the reevaluating comprises:
executing, based on the subsequent natural language utterance, a search on the current session context instance, the data store, or both,
based on the search, determining the subsequent natural language utterance satisfies the threshold level of similarity with the same or different one or more topics represented in the current session context instance, the data store, or both,
responsive to determining the subsequent natural language utterance satisfies the threshold level of similarity with the same or different one or more topics, identifying the same or different topic context instance associated with the same or different one or more topics, and
associating the subsequent natural language utterance with the same or different topic context instance.

8. The computer-implemented method of claim 1, wherein:
the natural language utterance references a prior conversation between the user and the digital assistant;
obtaining the topic context instance for the natural language utterance further comprises:
based on the reference to the prior conversation and the search, identifying a past topic context instance associated with the same or different one or more topics, and
linking, using a virtual pointer, the topic context instance with the past topic context instance; and
the one or more executable actions are selected from the one or more candidate actions based on each of the one or more executable actions satisfying the threshold level of similarity with the natural language utterance, the context within the topic context instance, and additional context within the past topic context instance.

9. The computer-implemented method of claim 1, wherein:
responsive to determining the natural language utterance satisfies the threshold level of similarity with the one or more topics, identifying multiple topic context instances associated with the current session context instance and associated with the one or more topics; and
obtaining the topic context instance for the natural language utterance further comprises merging the multiple topic context instances to create the topic context instance as a composite of the multiple topic context instances.

10. The computer-implemented method of claim 9, wherein:
the context within the topic context instance includes a conversation history between the user and the digital assistant;
context within each of the multiple topic context instances includes additional conversation history between the user and the digital assistant; and
merging the multiple topic context instances includes concatenating the conversation history with each of the additional conversation histories.

11. The computer-implemented method of claim 1, wherein:
the one or more candidate actions are identified as being associated with the topic context instance by executing, using the natural language utterance, a semantic search of potential actions represented in the data store that are associated with the digital assistant;
the potential actions have a zero confidence level for satisfying the threshold level of similarity with the natural language utterance and the context within the topic context instance;
the one or more candidate actions have a positive confidence level for satisfying the threshold level of similarity with the natural language utterance and the context within the topic context instance, and
the one or more executable actions have a positive confidence level and do satisfy the threshold level of similarity with the natural language utterance and the context within the topic context instance, based on which the the first generative artificial intelligence model predicts that the one or more executable actions are relevant for responding to the natural language utterance with a high confidence level.

12. The computer-implemented method of claim 11, further comprising:
constructing, based on the topic context instance, an input prompt comprising the one or more candidate actions, at least a portion of the context associated with the topic context instance, and the natural language utterance; and
providing the input prompt to the first generative artificial intelligence model, wherein the first generative artificial intelligence model generates the list comprising the executable action based on the input prompt.

13. The computer-implemented method of claim 1, further comprising:
executing, based on the one or more candidate actions, a search on user-preferences in the data store to identify one or more user-preferences that are relevant to the one or more candidate actions, wherein the creating the execution plan comprises embedding the one or more user-preferences into the execution plan.

14. The computer-implemented method of claim 1, wherein:
the context within the topic context instance includes a conversation history between the user and the digital assistant; and
the current session context instance is associated with the topic context instance and one or more other topic context instances, each of the one or more other topic context instances includes additional conversation history between the user and the digital assistant.

15. The computer-implemented method of claim 14, further comprising:
generating a summary of the conversation history and the additional conversation history between the user and the digital assistant;
revising the current session context instance to include the summary of the conversation history; and
computing performance metrics for the digital assistant based on the revised current session context instance.

16. The computer-implemented method of claim 1, further comprising:
constructing, based on the output and the topic context instance, an input prompt comprising the output, at least a portion of the context associated with the topic context instance, and the natural language utterance;
providing the input prompt to a second generative artificial intelligence model; and
generating, by the second generative artificial intelligence model, a response to the natural language utterance based on the input prompt, wherein the response is the communication derived from the output.

17. A system comprising:
one or more processing systems; and
one or more computer-readable media storing instructions which, when executed by the one or more processing systems, cause the system to perform operations comprising:
receiving, at a digital assistant, a natural language utterance from a user during a session between the user and the digital assistant;
obtaining a topic context instance for the natural language utterance, wherein the obtaining comprises:
executing, based on the natural language utterance, a search on a current session context instance, a data store, or both,
based on the search, determining whether the natural language utterance satisfies a threshold level of similarity with one or more topics represented in the current session context instance, the data store, or both,
responsive to determining the natural language utterance satisfies the threshold level of similarity with the one or more topics, identifying the topic context instance associated with the one or more topics, and
associating the natural language utterance with the topic context instance;
generating, by a first generative artificial intelligence model, a list comprising one or more executable actions based on one or more candidate actions associated with the topic context instance;
creating, based on the list, an execution plan comprising the one or more executable actions;
generating an updated topic context instance by updating the topic context instance to include the execution plan;
executing the execution plan based on the updated topic context instance, wherein the executing comprises executing the executable action using an asset to obtain an output; and
sending the output or a communication derived from the output to the user.

18. The system of claim 17, wherein generating the list comprises selecting the one or more executable actions from the one or more candidate actions based on each of the one or more executable actions satisfying a threshold level of similarity with the natural language utterance and context within the topic context instance.

19. The system of claim 17, wherein the operations further comprise:
responsive to a user logging into an application associated with the digital assistant, creating the current session context instance for the session,
wherein the current session context instance comprises prior natural language utterances from the user during the session between the user and the digital assistant, and wherein each of the prior natural language utterances (a) is resolved and associated with the topic context instance or other topic context instance associated with the current session context instance or (b) is unresolved and associated with a tentative topic context instance.

20. The system of claim 17, wherein:
the digital assistant is configured to handle a plurality of actions associated with a plurality of topics including the one or more topics;
the topic context instance is specific to the one or more topics and is associated one or more actions of the plurality of actions; and
determining whether the natural language utterance satisfies the threshold level of similarity with the one or more topics is a function of similarity between the natural language utterance and the associated one or more actions.

21. The system of claim 17, wherein the operations further comprise:
receiving, at the digital assistant, a subsequent natural language utterance from the user during the session between the user and the digital assistant;
obtaining a tentative topic context instance for the subsequent natural language utterance, wherein the obtaining comprises:
executing, based on the subsequent natural language utterance, a search on the current session context instance, the data store, or both,
based on the search, determining the subsequent natural language utterance does not satisfy the threshold level of similarity with one or more topics represented in the current session context instance, the data store, or both,
responsive to determining the subsequent natural language utterance does not satisfy the threshold level of similarity with the one or more topics, creating the tentative topic context instance associated with the current session context instance, and
associating the subsequent natural language utterance with the tentative topic context instance.

22. The system of claim 21, wherein the operations further comprise:
receiving, at the digital assistant, another subsequent natural language utterance from the user during the session between the user and the digital assistant;
obtaining the topic context instance for the another subsequent natural language utterance, wherein the obtaining comprises:
executing, based on the another subsequent natural language utterance, a search on the current session context instance, the data store, or both,
based on the search, determining the another subsequent natural language utterance satisfies the threshold level of similarity with the same or different one or more topics represented in the current session context instance, the data store, or both,
responsive to determining the another subsequent natural language utterance satisfies the threshold level of similarity with the same or different one or more topics, identifying the same or different topic context instance associated with the same or different one or more topics, and
associating the another subsequent natural language utterance with the same or different topic context instance.

23. The system of claim 22, wherein the operations further comprise:
responsive to receiving the another subsequent natural language utterance from the user, reevaluating the subsequent natural language utterance associated with the tentative topic context instance, wherein the reevaluating comprises:
executing, based on the subsequent natural language utterance, a search on the current session context instance, the data store, or both,
based on the search, determining the subsequent natural language utterance satisfies the threshold level of similarity with the same or different one or more topics represented in the current session context instance, the data store, or both,
responsive to determining the subsequent natural language utterance satisfies the threshold level of similarity with the same or different one or more topics, identifying the same or different topic context instance associated with the same or different one or more topics, and
associating the subsequent natural language utterance with the same or different topic context instance.

24. The system of claim 17, wherein:
the natural language utterance references a prior conversation between the user and the digital assistant;
obtaining the topic context instance for the natural language utterance further comprises:
based on the reference to the prior conversation and the search, identifying a past topic context instance associated with the same or different one or more topics, and
linking, using a virtual pointer, the topic context instance with the past topic context instance; and
the one or more executable actions are selected from the one or more candidate actions based on each of the one or more executable actions satisfying the threshold level of similarity with the natural language utterance, the context within the topic context instance, and additional context within the past topic context instance.

25. The system of claim 17, wherein:
responsive to determining the natural language utterance satisfies the threshold level of similarity with the one or more topics, identifying multiple topic context instances associated with the current session context instance and associated with the one or more topics; and
obtaining the topic context instance for the natural language utterance further comprises merging the multiple topic context instances to create the topic context instance as a composite of the multiple topic context instances.

26. The system of claim 25, wherein:
the context within the topic context instance includes a conversation history between the user and the digital assistant;
context within each of the multiple topic context instances includes additional conversation history between the user and the digital assistant; and
merging the multiple topic context instances includes concatenating the conversation history with each of the additional conversation histories.

27. One or more non-transitory computer-readable media storing instructions which, when executed by one or more processors, cause a system to perform operations comprising:
receiving, at a digital assistant, a natural language utterance from a user during a session between the user and the digital assistant;
obtaining a topic context instance for the natural language utterance, wherein the obtaining comprises:
executing, based on the natural language utterance, a search on a current session context instance, a data store, or both,
based on the search, determining whether the natural language utterance satisfies a threshold level of similarity with one or more topics represented in the current session context instance, the data store, or both,
responsive to determining the natural language utterance satisfies the threshold level of similarity with the one or more topics, identifying the topic context instance associated with the one or more topics, and
associating the natural language utterance with the topic context instance;
generating, by a first generative artificial intelligence model, a list comprising one or more executable actions based on one or more candidate actions associated with the topic context instance;
creating, based on the list, an execution plan comprising the one or more executable actions;
generating an updated topic context instance by updating the topic context instance to include the execution plan;
executing the execution plan based on the updated topic context instance, wherein the executing comprises executing the executable action using an asset to obtain an output; and
sending the output or a communication derived from the output to the user.

28. The one or more non-transitory computer-readable media of claim 27, wherein generating the list comprises selecting the one or more executable actions from the one or more candidate actions based on each of the one or more executable actions satisfying a threshold level of similarity with the natural language utterance and context within the topic context instance.

29. The one or more non-transitory computer-readable media of claim 27, wherein the operations further comprise:
responsive to a user logging into an application associated with the digital assistant, creating the current session context instance for the session,
wherein the current session context instance comprises prior natural language utterances from the user during the session between the user and the digital assistant, and wherein each of the prior natural language utterances (a) is resolved and associated with the topic context instance or other topic context instance associated with the current session context instance or (b) is unresolved and associated with a tentative topic context instance.

30. The one or more non-transitory computer-readable media of claim 27, wherein:
the digital assistant is configured to handle a plurality of actions associated with a plurality of topics including the one or more topics;
the topic context instance is specific to the one or more topics and is associated one or more actions of the plurality of actions; and
determining whether the natural language utterance satisfies the threshold level of similarity with the one or more topics is a function of similarity between the natural language utterance and the associated one or more actions.
